(19) United States
(12) Patent Application Publication
(10) Pub. No.: US 2025/0117966 A1
(43) Pub. Date: Apr. 10, 2025

(54) MODEL TRAINING METHOD, VIDEO ENCODING METHOD, AND VIDEO DECODING METHOD

(71) Applicant: Alibaba (China) Co., Ltd., Hangzhou (CN)

(72) Inventors: Bolin CHEN, Beijing (CN); Zhao Wang, Beijing (CN); Yan Ye, San Diego, CA (US); Shiqi Wang, Hong Kong (CN)

(21) Appl. No.: 18/988,585

(22) Filed: Dec. 19, 2024

Related U.S. Application Data
(63) Continuation of application No. PCT/CN2023/101961, filed on Jun. 13, 2023.

(30) Foreign Application Priority Data
Jun. 23, 2022 (CN) 202210716223.2

(51) Int. Cl. G06T 9/00; H04N 19/58

(52) U.S. Cl. CPC G06T 9/002; H04N 19/58

(57) ABSTRACT

A method including deforming the reference sample frame through generator in an initial generative model to generate reconstructed sample frames; inputting each reconstructed sample frame and the corresponding to-be-encoded sample frame into a first discriminator in the initial generative model to obtain a first identification result; splicing the to-be-encoded sample frames in timestamp order to obtain a spliced to-be-encoded sample frame, and splicing the reconstructed sample frames to obtain a spliced reconstructed sample frame; inputting the spliced to-be-encoded sample frame and the spliced reconstructed sample frame into a second discriminator in the initial generative model to obtain a second identification result; obtaining an adversarial loss value based on the first identification result and the second identification result; and training the initial generative model based on the adversarial loss value. The reconstructed video frame sequence and the to-be-encoded video frame sequence are consistent in time domain, thereby improving the reconstruction quality.

### CROSS REFERENCE TO RELATED APPLICATION

This application claims priority to and is a continuation of PCT Patent Application No. PCT/CN2023/101961, filed on 21 Jun. 2023 and entitled “MODEL TRAINING METHOD, VIDEO ENCODING METHOD, AND VIDEO DECODING METHOD,” which claims priority to Chinese Patent Application No. 202210716223.2, filed on 23 Jun. 2022 and entitled “MODEL TRAINING METHOD, VIDEO ENCODING METHOD, AND VIDEO DECODING METHOD,” all of which are incorporated herein by reference in their entirety.

### TECHNICAL FIELD

Embodiments of the present disclosure relate to the field of computer technology, and more particularly, to model training methods, video encoding methods, and decoding methods.

### BACKGROUND

Video encoding and decoding is the key to achieve video conferencing, live video broadcasting, etc. With the continuous development of machine learning, a codec method based on deep video generation may be used to perform video (especially facial videos) encoding and decoding operations. This method mainly uses the generator, a neural network model, in a generative model to deform a reference frame based on the movement of a to-be-encoded frame, and generate a reconstructed frame corresponding to the to-be-encoded frame.

During a model training phase, the above-mentioned generative model is usually a generative adversarial network including a generator and a discriminator. During training, to-be-encoded video frames and reconstructed video frames generated by the generator are inputted into the discriminator, which performs authenticity identification and outputs identification results. Then, a loss function is constructed based on the identification results to complete the model training.

However, in the related technologies, when a discriminator performs authenticity identification, it only considers the similarity between the reconstructed video frame and the to-be-encoded video frame in the spatial domain, i.e., only the similarity between a single reconstructed video frame and the corresponding to-be-encoded video frame is compared. When the above generative model is used to reconstruct video frames, resulting reconstructed video frame sequences (reconstructed video clips) usually have phenomena of visual flickering and floating artifacts, and the video reconstruction quality is relatively poor.

### SUMMARY

In light of the foregoing, embodiments of the present disclosure provide a model training method, a video encoding method, and a decoding method to at least partially solve the above-mentioned problem.

According to a first aspect of the embodiments of the present specification, a model training method is provided, comprising:
acquiring a reference sample frame and a plurality of consecutive to-be-encoded sample frames;
deforming the reference sample frame by using a generator in an initial generative model to generate reconstructed sample frames corresponding to each of the to-be-encoded sample frames;
inputting each reconstructed sample frame and the corresponding to-be-encoded sample frame into a first discriminator in the initial generative model to obtain a first identification result;
according to a timestamp order, splicing all the to-be-encoded sample frames to obtain a spliced to-be-encoded sample frame, and splicing all the reconstructed sample frames to obtain a spliced reconstructed sample frame; inputting the spliced to-be-encoded sample frame and the spliced reconstructed sample frame into a second discriminator of the initial generative model to obtain a second identification result; and
obtaining an adversarial loss value based on the first identification result and the second identification result, and training the initial generative model based on the adversarial loss value to obtain a trained generative model.

According to a second aspect of the embodiments of the present specification, a video decoding method is provided, comprising:
acquiring and decoding a video bitstream to obtain a reference video frame and to-be-encoded features;
extracting features from the reference video frame to obtain reference features; and
performing, based on the to-be-encoded features and the reference features, motion estimation to obtain a motion estimation result;
deforming, based on the motion estimation result, the reference video frame using a generator in a pre-trained generative model to generate a reconstructed video frame,
wherein the generative model is obtained using the model training method according to the first aspect.

According to a third aspect of the embodiments of the present disclosure, a video decoding method is provided, which is applied to a conference terminal device, and the method comprises:
acquiring and decoding a video bitstream to obtain a reference video frame and to-be-encoded features, wherein after a video clip captured by a video capture device is acquired and features of a to-be-encoded video frame in the video clip are extracted to obtain to-be-encoded features, the video bitstream is obtained by encoding the to-be-encoded features and the reference video frame in the video clip;
extracting features from the reference video frame to obtain reference features; and performing, based on the to-be-encoded features and the reference features, motion estimation to obtain a motion estimation result;
deforming, based on the motion estimation result, the reference video frame using a generator in a pre-trained generative model to generate a reconstructed video frame, wherein
displaying the reconstructed video frame in a display interface,
wherein the generative model is obtained using the model training method according to the first aspect.

According to a fourth aspect of the embodiments of the present disclosure, an electronic device is provided, comprising: a processor, a memory, a communications interface, and a communications bus, wherein the processor, the memory, and the communications interface communicate with each other through the communications bus; the memory is configured to store at least one executable instruction that causes the processor to execute operations corresponding to the model training method according to the first aspect or operations corresponding to the video decoding method according to the second aspect or the third aspect.

According to a fifth aspect of the embodiments of the present disclosure, a computer storage medium having stored thereon a computer program is provided, wherein the program, when executed by a processor, is enabled to implement the model training method according to the first aspect or the video decoding method according to the second aspect or the third aspect.

According to a sixth aspect of the present disclosure, a computer program product comprising computer instructions is provided, wherein the computer instructions instruct a computing device to perform operations corresponding to the model training method according to the first aspect, or operations corresponding to the video decoding method according to the second aspect or the third aspect.

The model training method provided in the embodiments of the present disclosure generates reconstructed sample frames corresponding to a plurality of consecutive to-be-coded sample frames through the generator in the initial generative model. While an authenticity identification on a single reconstructed sample frame and the corresponding to-be-encoded sample frame is performed, another authenticity identification is also performed on the spliced reconstructed sample frame spliced together from all the reconstructed sample frames in the timestamp order and the spliced to-be-encoded sample frame spliced together from all the to-be-encoded sample frames in the timestamp order. Further, the adversarial loss value is generated based on the identification results from the single sample frames (first identification results) and the identification results from the spliced sample frames (second identification results), thereby completing the training of the initial generative model. That is, in the embodiments of the present disclosure, when an authenticity identification is performed, not only the similarity between the reconstructed sample frame and the to-be-encoded sample frame in the spatial domain is considered, the similarity between the reconstructed sample frame and the to-be-encoded sample frame in the temporal domain is also considered. In other words, by comparing the similarity between the spliced to-be-encoded sample frame and the spliced reference sample frame, it is considered whether there is a continuous relationship between the consecutive reconstructed sample frames in the temporal domain that is present in the consecutive to-be-encoded sample frames. Therefore, by training the model based on the above identification results and reconstructing the video frames based on the trained generative model, the reconstructed video frame sequences are kept consistent with the to-be-encoded video frame sequences in the temporal domain, thereby improving the phenomena of flickering and floating artifacts and enhancing the video reconstruction quality.

### BRIEF DESCRIPTION OF DRAWINGS

In order to more clearly describe the technical solutions in the embodiments of the present disclosure, the following briefly describes the accompanying drawings needed for describing the embodiments. Apparently, the accompanying drawings described below only show some of the embodiments of the present disclosure, and those of ordinary skill in the art may derive other accompanying drawings therefrom.

FIG. 1 is a schematic diagram of a framework of an encoding and decoding method based on deep video generation;

FIG. 2 is a flowchart of steps of a model training method according to Embodiment I of the present disclosure;

FIG. 3 is a schematic diagram of a network architecture of a generative model according to the embodiment shown in FIG. 2;

FIG. 4 is a flowchart of steps of a model training method according to Embodiment II of the present disclosure;

FIG. 5 is a schematic diagram of a scenario example according to the embodiment shown in FIG. 4;

FIG. 6 is a flowchart of steps of a video encoding method according to Embodiment III of the present disclosure;

FIG. 7 is a flowchart of steps of a video decoding method according to Embodiment IV of the present disclosure;

FIG. 8 is a flowchart of steps of a video decoding method according to Embodiment V of the present disclosure;

FIG. 9 is a structural block diagram of a model training apparatus according to Embodiment VI of the present disclosure;

FIG. 10 is a structural block diagram of a video encoding apparatus according to Embodiment VII of the present disclosure;

FIG. 11 is a structural block diagram of a video decoding apparatus according to Embodiment VIII of the present disclosure;

FIG. 12 is a structural block diagram of a video decoding apparatus according to Embodiment IX of the present disclosure; and

FIG. 13 is a schematic diagram of the structure of an electronic device according to Embodiment X of the present disclosure.

### DESCRIPTION OF EMBODIMENTS

In order to enable those skilled in the art to better understand the technical solution in the embodiments of the present disclosure, the technical solution in the embodiments of the present disclosure will be clearly and completely described below with reference to the accompanying drawings in the embodiments of the present disclosure. Obviously, the described embodiments are merely some but not all of the embodiments of the present disclosure. Based on the embodiments of the present disclosure, all other embodiments obtained by those of ordinary skill in the art shall fall within the protection scope of the embodiments of the present disclosure.

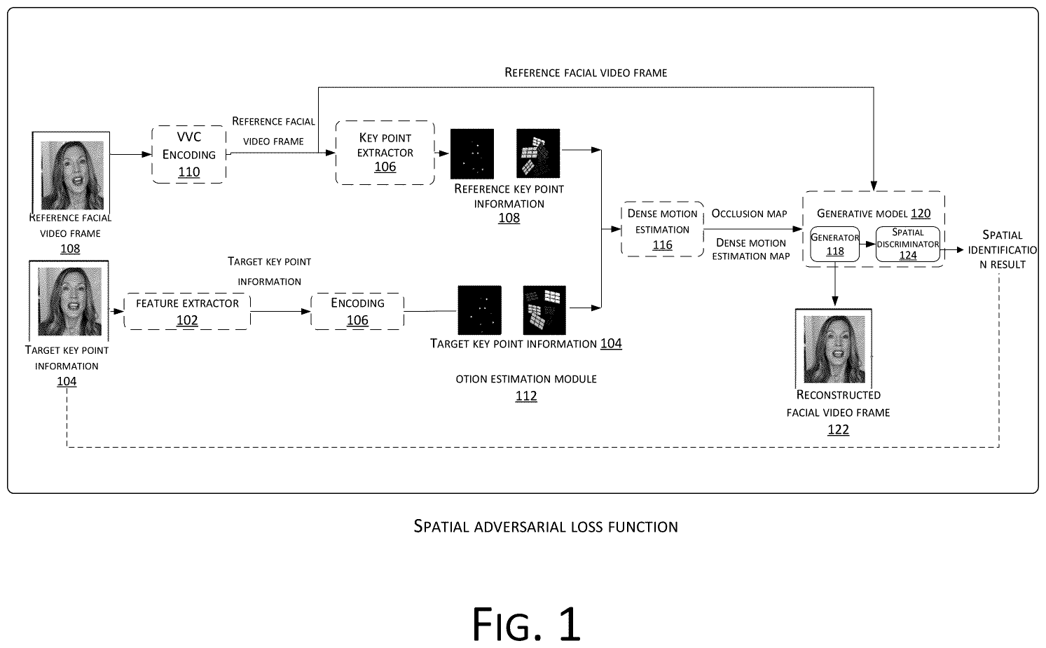

The main principle of the encoding and decoding method based on deep video generation is to use the generator in the generative model to deform the reference frame based on the movement of the to-be-encoded frame, so as to obtain a reconstructed frame corresponding to the to-be-encoded frame. Please refer to FIG. 1, a schematic diagram of a framework of the model training stage in the encoding and decoding method based on deep video generation. In the training stage, the generative model usually adopts a generative adversarial network composed of a generator and a spatial discriminator. After the generator obtains the reconstructed frame, the reconstructed frame and the to-be-encoded frame are inputted into the spatial discriminator, which performs authenticity identification and outputs the spatial identification result. Then, a spatial adversarial loss function is constructed based on the spatial identification result to complete the model training.

The basic framework of the training process is explained below in combination with FIG. 1.

In the first step, the encoding stage, an encoder uses a feature extractor 102 to extract target key point information 104 of a single target facial to-be-encoded video frame, and encodes 106 the target key point information 104. At the same time, a reference facial video frame 108 is encoded using the traditional image encoding methods (such as VVC encoding 110, HEVC, etc.).

The second step is the decoding stage. A motion estimation model 112 in the decoder extracts the reference key point information 108 of the reference facial video frame through a key point extractor 114, and performs dense motion estimation 116 based on the reference key point information 108 and the target key point information 104 to obtain a dense motion estimation map and an occlusion map. The dense motion estimation map represents the relative motion relationship between the target facial video frame and the reference facial video frame in the feature domain represented by the key point information. The occlusion map represents the degree of occlusion of each pixel in the target facial video frame.

The third step is the decoding stage. A generator 118 inside the generative model 120 in the decoder deforms the reference facial video frame based on the dense motion estimation map to obtain a deformation result, and then multiplies the deformation result with the occlusion map to output the reconstructed facial video frame 122. At the same time, after the generator obtains the reconstructed frame, the reconstructed frame and the to-be-encoded frame are inputted into the spatial discriminator 124, which performs authenticity identification and outputs a spatial identification result.

The fourth step is the model training stage. Based on the spatial identification results and the target facial video frame, a spatial adversarial loss value is generated. Then, the model is trained according to the above spatial adversarial loss value, and a trained feature extractor (feature extraction model), a trained motion estimation model, and a trained generative model are obtained.

In the training method shown in FIG. 1, when the spatial discriminator performs authenticity identification, it considers only the similarity between a single reconstructed video frame and its corresponding to-be-encoded video frame in the spatial domain, i.e., only the similarity between a single reconstructed video frame and the corresponding to-be-encoded video frame is compared. When the above generative model is used to reconstruct video frames, the resulting reconstructed video frame sequences (reconstructed video clips) are usually visually characterized by flickering and floating artifacts, and the video reconstruction quality is relatively poor.

In the embodiments of the present disclosure, reconstructed sample frames corresponding to a plurality of consecutive to-be-coded sample frames are generated through the generator in the initial generative model. While an authenticity identification on a single reconstructed sample frame and the corresponding to-be-encoded sample frame is performed using the first discriminator (spatial discriminator), another authenticity identification is also performed using the second discriminator (temporal discriminator) on the spliced reconstructed sample frame spliced together from all the reconstructed sample frames in the timestamp order and the spliced to-be-encoded sample frame spliced together from all the to-be-encoded sample frames in the timestamp order. As such, the adversarial loss value is generated based on the identification results from the single sample frames (first identification results) and the identification results from the spliced sample frames (second identification results), and the training of the initial generative model may then be completed. That is to say, in the embodiments of the present disclosure, when an authenticity identification is performed, not only the similarity between the reconstructed sample frame and the to-be-encoded sample frame in the spatial domain is considered, the similarity between the reconstructed sample frame and the to-be-encoded sample frame in the temporal domain is also considered. In other words, by comparing the similarity between the spliced to-be-encoded sample frame and the spliced reference sample frame, it is considered whether there is a continuous relationship between the consecutive reconstructed sample frames in the temporal domain that is present in the consecutive to-be-encoded sample frames. Therefore, by training the model based on the above identification results and reconstructing the video frames based on the trained generative model, the reconstructed video frame sequences can be kept consistent with the to-be-encoded video frame sequences in the temporal domain, thereby improving the phenomena of flickering and floating artifacts and enhancing the video reconstruction quality.

The implementation of the embodiments of the present disclosure will be further illustrated with reference to the accompanying drawings of the embodiments of the present disclosure.

### Embodiment I

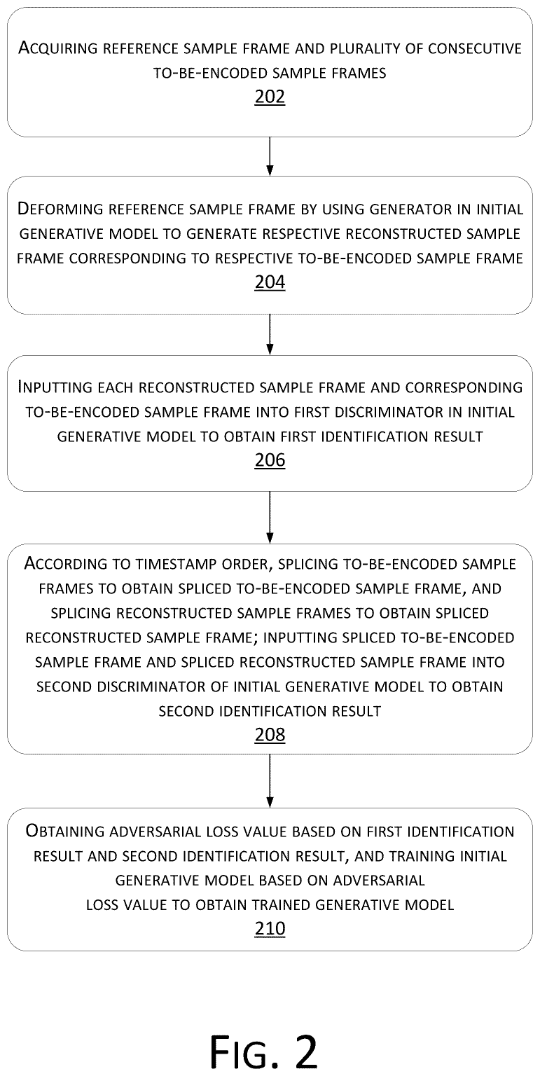

Please refer to FIG. 2, which is a flowchart of steps of a model training method according to Embodiment I of the present disclosure. For example, the model training method provided in this embodiment comprises the following steps:

S202: acquiring a reference sample frame and a plurality of consecutive to-be-encoded sample frames.

For example, the reference sample frame and each to-be-encoded sample frame in the embodiment of the present disclosure may be video frames derived from the same video sample. Further, the reference sample frame and each to-be-encoded sample frame may be facial video frames.

S204: deforming the reference sample frame using a generator in an initial generative model to generate reconstructed a respective sample frames corresponding to a respective to-be-encoded sample frames.

For example, the reconstructed sample frame may be obtained in the following manner:
performing, for each to-be-encoded sample frame, motion estimation on the to-be-coded sample frame based on reference sample features, so as to obtain the motion estimation results; inputting the reference sample frame and the motion estimation result into the generator in the initial model to obtain the reconstructed sample frames corresponding to the to-be-encoded sample frames. The motion estimation result represents the relative motion relationship between the reference sample frame and the to-be-encoded sample frame in a preset feature domain.

Furthermore, it is possible to: extract reference sample features of the reference sample frame and to-be-coded sample features of each of the to-be-encoded sample frames. For each to-be-encoded sample frame, motion estimation is performed based on the reference sample features and the to-be-coded sample features of the to-be-encoded sample frame, so as to obtain a motion estimation result. The reference sample frame and the motion estimation result are inputted into the initial generator to obtain the reconstructed sample frames corresponding to the to-be-encoded sample frames.

S206: inputting each reconstructed sample frame and the corresponding to-be-encoded sample frame into a first discriminator in the initial generative model to obtain a first identification result.

The first discriminator in the embodiment of the present disclosure may also be referred to as a spatial discriminator. For example, for a certain reconstructed sample frame and a corresponding to-be-encoded sample frame, after the two sample frames are inputted into the first discriminator, features of the two sample frames are respectively extracted thereby to obtain respective feature maps of the two sample frames (reconstructed feature map and to-be-encoded feature map). Then, through the comparison of the distributions of the two feature maps in the spatial domain to see if the two are similar, a first output result characterizing whether the two sample frames are the same (or whether the two sample frames are similar enough) is obtained. For example: when the first output result is: 1 (true), this indicates that the two sample frames are the same; and when the first output result is: 0 (false), it indicates that the two sample frames are different sample frames. In the embodiment of the present disclosure, the first identification result may include: a feature map of the reconstructed sample frame extracted by the first discriminator (hereinafter referred to as: the first identification result of the reconstructed sample frame), a feature map of the to-be-encoded sample frame extracted by the first discriminator (hereinafter referred to as: the first identification result of the to-be-encoded sample frame), and the above-mentioned first output result.

S208: according to a timestamp order, splicing the to-be-encoded sample frames to obtain a spliced to-be-encoded sample frame, and splicing the reconstructed sample frames to obtain a spliced reconstructed sample frame; inputting the spliced to-be-encoded sample frame and the spliced reconstructed sample frame into a second discriminator of the initial generative model to obtain a second identification result.

The second discriminator in the embodiment of the present disclosure may also be referred to as a temporal discriminator. Similar to the first discriminator, for the spliced reconstructed sample frame and the corresponding spliced to-be-encoded sample frame, after the two sample frames are inputted into the second discriminator, features of the two sample frames are respectively extracted thereby to obtain respective feature maps of the two sample frames. Then, through the comparison of the distributions of the two feature maps in the spatial domain to see if the two are similar, a second output result characterizing whether the two sample frames are the same (or whether the two sample frames are similar enough) is obtained. In the embodiment of the present disclosure, the second identification result may include: a feature map of the spliced reconstructed sample frame extracted by the second discriminator (hereinafter referred to as: the second identification result of the spliced reconstructed sample frame), a feature map of the spliced to-be-encoded sample frame extracted by the second discriminator (hereinafter referred to as: the second identification result of the spliced to-be-encoded sample frame), and the above-mentioned second output result.

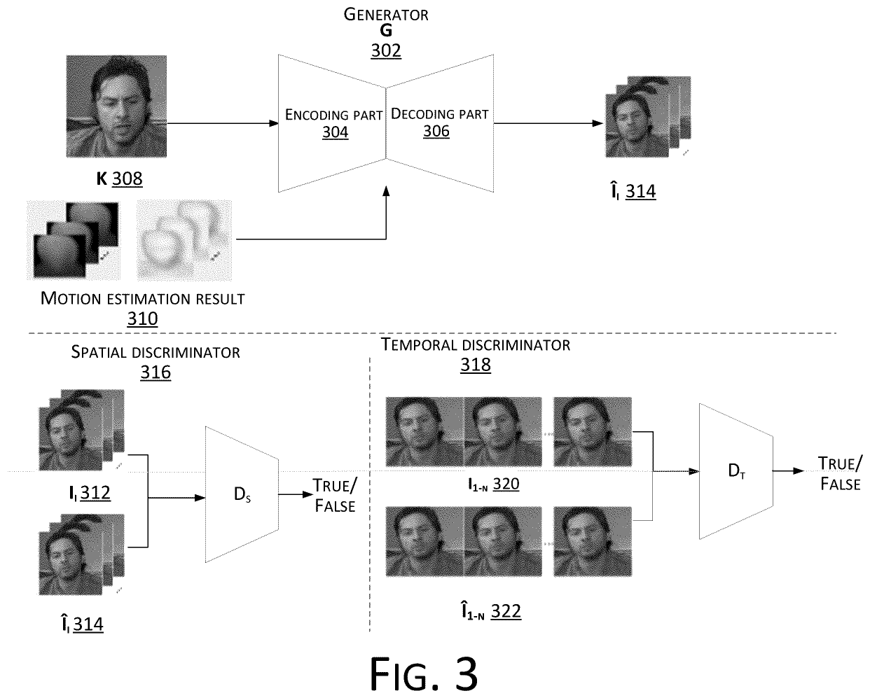

In the embodiment of the present disclosure, the generative model includes: a generator, a first discriminator, and a second discriminator, wherein the first discriminator and the second discriminator are connected in parallel after the generator to perform authenticity identification based on the reconstructed sample frames outputted by the generator. For example, please refer to FIG. 3, which is a schematic diagram of a network architecture of a generative model according to the embodiment shown in FIG. 2.

The generator G 302 includes an encoding part 304 and a decoding part 306. The reference sample frame K 308 and a motion estimation result 310 corresponding to a single to-be-encoded sample frame Iᵢ 312 in the consecutive to-be-encoded sample frames I₁, I₂, . . . , Iₙ are inputted into the generator 302. Through the encoding part 304 and the decoding part 306 of the generator 302, the reconstructed sample frame Îᵢ 314 corresponding to the to-be-encoded sample frame Iᵢ 312 is finally outputted, thereby finally obtaining the reconstructed sample frames: Î₁, Î₂, . . . , Îₙ. Here, i is a natural number greater than or equal to 1 and less than or equal to n.

The spatial discriminator (the first discriminator) Dₛ 316, located after the generator G 302, is configured to perform authenticity identification on a single reconstructed sample frame Îᵢ 314 and a corresponding to-be-encoded sample frame Iᵢ 312, so as to output a first output result. The temporal discriminator (the second discriminator) Dₜ 318, located after the generator and connected in parallel with the spatial discriminator Dₛ, is configured to perform authenticity identification on the spliced to-be-encoded sample frame I₁₋ₙ 320 and the spliced reconstructed sample frame Î₁₋ₙ, 322 so as to output a second output result.

S210: obtaining an adversarial loss value based on the first identification result and the second identification result, and training the initial generative model based on the adversarial loss value to obtain a trained generative model.

For example, in some embodiments, the adversarial loss value may include: a generative adversarial loss value, a spatial adversarial loss value, and a temporal adversarial loss value, each of which may be obtained in the following manner:
obtaining the generative adversarial loss value based on the first identification results of each reconstructed sample frames, wherein the greater the sum of the first identification results of each reconstructed sample frames is, the smaller the generative adversarial loss value will be;
obtaining the spatial adversarial loss value based on a difference between the first identification result of each reconstructed sample frame and the first identification result of the corresponding to-be-encoded sample frame, wherein the smaller the difference between the first identification result of each reconstructed sample frame and the first identification result of the corresponding to-be-encoded sample frame, the smaller the spatial adversarial loss value will be; and
obtaining the temporal adversarial loss value based on a difference between the second identification result of the spliced to-be-encoded sample frame and the second identification result of the spliced reconstructed sample frame. Herein, the smaller the difference between the second identification result of the spliced to-be-encoded sample frame and the second identification result of the spliced reconstructed sample frame is, the smaller the temporal adversarial loss value will be.

As described above, the first identification result of each reconstructed sample frame can be the feature map of each reconstructed sample frame extracted by the first discriminator; the first identification result of the to-be-encoded sample frame can be the feature map of the to-be-encoded sample frame extracted by the first discriminator; the second identification result of the spliced to-be-encoded sample frame can be the feature map of the spliced to-be-encoded sample frame extracted by the second discriminator; and the second identification result of the spliced reconstructed sample frame can be the feature map of the spliced reconstructed sample frame extracted by the second discriminator.

Further, the generative adversarial loss value may be obtained as follows:
acquiring a probability distribution of the first identification result of each reconstructed sample frame as a first reconstruction probability distribution for each reconstructed sample frame; and obtaining the generative adversarial loss value based on an expected value of the first reconstruction probability distribution for each reconstructed sample frame;
the spatial adversarial loss value may be obtained in the following manner: acquiring a probability distribution of the first identification result of each to-be-encoded sample frame as a first to-be-encoded probability distribution for each to-be-encoded sample frame; and obtaining the spatial adversarial loss value based on an expected difference between the expected value of the first reconstructed probability distribution for each reconstructed sample frame and an expected value of the first to-be-encoded probability distribution for each to-be-encoded sample frame;
the temporal adversarial loss value may be obtained in the following manner: acquiring a probability distribution of the second identification result of the spliced reconstructed sample frame as a second reconstructed probability distribution; acquiring a probability distribution of the second identification result of the spliced to-be-encoded sample frame as a second to-be-encoded probability distribution; and obtaining the temporal adversarial loss value based on an expected difference between an expected value of the second reconstructed probability distribution and an expected value of the second to-be-encoded probability distribution.

For example, for generative adversarial loss values, the sum of the expected values of the first reconstruction probability distributions of each of the reconstructed sample frames may be used as the generative adversarial loss value. The larger the sum of the above expected values is, the smaller the generative adversarial loss value will be. Furthermore, the above generative adversarial loss value may be expressed using the following equation:

$${L}_{G} = - {\sum }_{i = 1}^{n} {E}_{{\hat{I}}_{i} ∼ {P}_{g}} [ {D}_{s} ( {\hat{I}}_{i} ) ]$$

Herein, L_{G} represents the generative adversarial loss value; Dₛ(Îᵢ) represents the first identification result of the reconstructed sample frame Îᵢ; P_{g}[Dₛ(Îᵢ)] represents the probability distribution of Dₛ(Îᵢ), i.e., the first reconstructed probability distribution of the reconstructed sample frame Îᵢ; E_{Î}_{ₜ}_{˜P}_{_{g}}[Dₛ(Îᵢ)] represents the expected value of the first reconstructed probability distribution of the reconstructed sample frame Îᵢ; n is the total number of the reconstructed sample frames, i.e., the total number of to-be-encoded sample frames.

Furthermore, since the first discriminator and the second discriminator usually include multiple different operation layers, for each reconstructed sample frame, the expected value corresponding to the probability distribution of the identification results (the feature map extracted by each operation layer) outputted by each operation layer of the first discriminator may be calculated separately, and then the expected values corresponding to the probability distribution of all operation layers can be summed to obtain the expected value corresponding to the probability distribution of the first identification result of the reconstructed sample frame. This enhances the realistic feeling of the reconstructed video frames.

For example, it can be expressed using the following equation:

$${L}_{G} = - {\sum }_{i = 1}^{n} {\sum }_{a = 1}^{k} {E}_{{\hat{I}}_{i} ∼ {P}_{g}} [ {D}_{s a} ( {\hat{I}}_{i} ) ]$$

Herein, Dₛₐ(Îᵢ) represents the identification result (the extracted feature map) of the reconstructed sample frame Îᵢ outputted by the a-th operation layer of the first discriminator; P_{g}[Dₛₐ(Îᵢ)] represents the probability distribution of Dₛₐ(Îᵢ); E_{Î}_{ᵢ}_{˜P}_{_{g}}[Dₛₐ(Îᵢ)] represents the expected value of P_{g}[Dₛₐ(Îᵢ)]; k is the total number of operation layers included in the first discriminator, also the total number of operation layers included in the second discriminator.

For the spatial adversarial loss value, the spatial adversarial loss value may be obtained based on an expected difference between the expected value of the first reconstructed probability distribution for each reconstructed sample frame and an expected value of the first to-be-encoded probability distribution for each to-be-encoded sample frame. The larger the above expected difference is, the greater the spatial adversarial loss value will be. Furthermore, the above spatial adversarial loss value may be expressed using the following equation:

$${L}_{{D}_{s}} = {\sum }_{i = 1}^{n} ( {E}_{{\hat{I}}_{i} ∼ {P}_{g}} [ {D}_{s} ( {\hat{I}}_{i} ) ] - {E}_{{I}_{i} ∼ {P}_{r}} [ {D}_{s} ( {I}_{i} ) ] )$$

Herein, L_{D}_{ₛ} represents the spatial adversarial loss value; Dₛ(Iᵢ) represents the first identification result of the to-be-encoded sample frame Iᵢ; Pᵣ[Dₛ(Iᵢ)] represents the probability distribution of Dₛ(Iᵢ); and E_{I}_{ᵢ}_{˜P}_{ᵣ}[Dₛ(Iᵢ)] is the expected value of Pᵣ[Dₛ(Iᵢ)].

Similar to the generative adversarial loss value, furthermore, the spatial adversarial loss value may be obtained using the following equation:

$${L}_{{D}_{s}} = {\sum }_{i = 1}^{n} {\sum }_{a = 1}^{k} ( {E}_{{\hat{I}}_{i} ∼ {P}_{g}} [ {D}_{s a} ( {\hat{I}}_{i} ) ] - {E}_{{I}_{i} ∼ {P}_{r}} [ {D}_{s a} ( {I}_{i} ) ] )$$

Herein, Dₛₐ(Iᵢ) represents the identification result (the extracted feature map) of the to-be-encoded sample frame Iᵢ outputted by the a-th operation layer of the first discriminator; Pᵣ[Dₛₐ(Iᵢ)] represents the probability distribution of Dₛₐ(Iᵢ); E_{I}_{ᵢ}_{˜P}_{ᵣ}[Dₛₐ(Îᵢ)] represents the expected value of Pᵣ[(Dₛₐ(Iᵢ)]; Dₛₐ(Îᵢ) represents the identification result (the extracted P_{g}[Dₛₐ(Îᵢ)] feature map) of Îᵢ outputted by the a-th operation layer of the first discriminator; represents the probability distribution of Dₛₐ(Îᵢ); and E_{I}_{ᵢ}_{˜P}_{_{g}}[Dₛₐ(Îᵢ)] represents the expected value of P_{g}[Dₛₐ(Îᵢ)].

For the temporal adversarial loss value, the greater the expected difference between the expected value of the second reconstructed probability distribution and the expected value of the second to-be-encoded probability distribution is, the greater the temporal adversarial loss value will be. Furthermore, the above temporal adversarial loss value may be expressed using the following equation:

$${L}_{{D}_{t}} = {E}_{{\hat{I}}_{1 - n} ∼ {P}_{g}} [ {D}_{t} ( {\hat{I}}_{1 - n} ) ] - {E}_{{I}_{1 - n} ∼ {P}_{r}} [ {D}_{t} ( {I}_{1 - n} ) ]$$

Herein, L_{D}_{ₜ} represents the temporal adversarial loss value; Dₜ(Î₁₋ₙ) represents the second identification result of the spliced reconstructed sample frame Î₁₋ₙ; P_{g}[Dₜ(Î₁₋ₙ)] represents the probability distribution of Dₜ(Î₁₋ₙ); E_{Î}_{₁₋ₙ}_{˜P}_{_{g}}[Dₜ(Î₁₋ₙ)] represents the expected value of P_{g}[Dₜ(I₁₋ₙ)]; Dₜ(I₁₋ₙ) represents the second identification result of the spliced to-be-encoded sample frame I₁₋ₙ; Pᵣ[Dₜ(I₁₋ₙ)] represents the probability distribution of Dₜ(I₁₋ₙ); and E_{I}_{₁₋ₙ}_{˜P}_{ᵣ}[Dₜ(I₁₋ₙ)] represents the expected value of Pᵣ[Dₜ(I₁₋ₙ)] Similar to the spatial adversarial loss value, the temporal adversarial loss value may be obtained using the following equation.

$${L}_{{D}_{t}} = {\sum }_{a = 1}^{k} {E}_{{\hat{I}}_{1 - n} ∼ {P}_{g}} [ {D}_{ta} ( {\hat{I}}_{1 - n} ) ] - {\sum }_{i = 1}^{k} {E}_{{I}_{1 - n} ∼ {P}_{r}} [ {D}_{ta} ( {I}_{1 - n} ) ]$$

Herein, Dₜₐ(Î₁₋ₙ) represents the identification result (the extracted feature map) of the spliced reconstructed sample frame Î₁₋ₙ outputted by the a-th operation layer of the second discriminator; E_{Î}_{₁₋ₙ}_{˜P}_{_{g}}[Dₜₐ(Î₁₋ₙ)] represents the expected value of the probability distribution of Dₜₐ(Î₁₋ₙ); Dₜₐ(I₁₋ₙ) represents the identification result (the extracted feature map) of the spliced to-be-encoded sample frame I₁₋ₙ outputted by the a-th operation layer of the second discriminator; and E_{I}_{₁₋ₙ}_{˜P}_{ᵣ}[Dₜₐ(I₁₋ₙ)] represents the expected value of the probability distribution of Dₜₐ(I₁₋ₙ).

For example, in some embodiments, before step 210, the method may further include: generating a perceptual loss value based on each reconstructed sample frame and each to-be-encoded sample frame; correspondingly, step 210 may include: training an initial generative model based on the adversarial loss value and the perceptual loss value to obtain a trained generative model.

For example, in some embodiments, step 204 may include:
performing, based on the reference sample frame, motion estimation on each to-be-encoded sample frame to obtain a motion estimation result for each to-be-encoded sample frame;
inputting, for each to-be-encoded sample frame, the reference sample frame and the motion estimation results of the to-be-encoded sample frame into the generator of the initial generative model, and deforming the reference sample frame through the generator to generate the reconstructed sample frames corresponding to the to-be-encoded sample frames.

Correspondingly, before step 210, the following steps may further be included:
inputting each to-be-encoded sample frame into a pre-trained motion prediction module to obtain actual motion results corresponding to each of the to-be-encoded samples; and
generating an optical flow loss value based on a difference between the motion estimation results and the actual motion results of each of the to-be-encoded sample frames.

The training the initial generative model based on the adversarial loss value and the perceptual loss value to obtain the trained generative model comprises:
training the initial generative model based on the adversarial loss value, the perceptual loss value, and the optical flow loss value to obtain the trained generative model.

For example, in the above embodiment, the motion prediction model may be a pre-trained neural network model for obtaining the relative motion relationship (i.e., the actual motion result) between the inputted to-be-encoded sample frame and the reference sample frame. In the embodiment of the present disclosure, there is no limitation on the specific structure of the prediction model. For example, it may be an end-to-end spatial pyramid network (SpyNet).

For the optical flow loss value, the greater the difference between the motion estimation results and the actual motion results of each of the to-be-encoded sample frames, the greater the optical flow loss value will be. In other words, the optical flow loss value can characterize the accuracy of the motion estimation result. Therefore, in the model training process, the motion estimation process may be supervised by further taking into account the optical flow loss value on top of the adversarial loss value and the perceptual loss value, so that when encoding and decoding operations are performed based on the trained model to obtain reconstructed video frames, the accuracy of the motion estimation process may be improved, thereby further improving the quality of the reconstructed video frames.

For example, in some embodiments, the process of generating an optical flow loss value based on a difference between the motion estimation results and the actual motion results of each of the to-be-encoded sample frames may include:
calculating, for each to-be-encoded sample frame, the difference between the motion estimation result and the actual motion result thereof as a motion difference corresponding to the to-be-encoded sample frame; and summing each motion difference as the optical flow loss value.

For example, the optical flow loss value may be calculated using the following equation.

$${L}_{flow} = {\sum }_{i = 1}^{n} \vert {M}_{original}^{i} - {M}_{dense}^{i} \vert$$

Herein, L_{flow} is the optical flow loss value; M_{original}ⁱ is the actual motion result of the to-be-encoded sample frame Iᵢ; M_{dense}ⁱ is the motion estimation result of the to-be-encoded sample frame Iᵢ; and n is the total number of the to-be-encoded sample frames.

The model training method provided in the embodiments of the present disclosure generates reconstructed sample frames corresponding to a plurality of consecutive to-be-coded sample frames through the generator in the initial generative model. While an authenticity identification on a single reconstructed sample frame and the corresponding to-be-encoded sample frame is performed, another authenticity identification is also performed on the spliced reconstructed sample frame spliced together from all the reconstructed sample frames in the timestamp order and the spliced to-be-encoded sample frame spliced together from all the to-be-encoded sample frames in the timestamp order. As such, the adversarial loss value is generated based on the identification results from the single sample frames (first identification results) and the identification results from the spliced sample frames (second identification results), thereby completing the training of the initial generative model. That is to say, in the embodiments of the present disclosure, when an authenticity identification is performed, not only the similarity between the reconstructed sample frame and the to-be-encoded sample frame in the spatial domain is considered, the similarity between the reconstructed sample frame and the to-be-encoded sample frame in the temporal domain is also considered. In other words, by comparing the similarity between the spliced to-be-encoded sample frame and the spliced reference sample frame, it is considered whether there is a continuous relationship between the consecutive reconstructed sample frames in the temporal domain that is present in the consecutive to-be-encoded sample frames. Therefore, by training the model based on the above identification results and reconstructing the video frames based on the trained generative model, the reconstructed video frame sequences can be kept consistent with the to-be-encoded video frame sequences in the temporal domain, thereby improving the phenomena of flickering and floating artifacts and enhancing the video reconstruction quality.

The model training method of the embodiment may be executed by any appropriate electronic device with data capabilities, including but not limited to: servers, PCs, and the like.

### Embodiment II

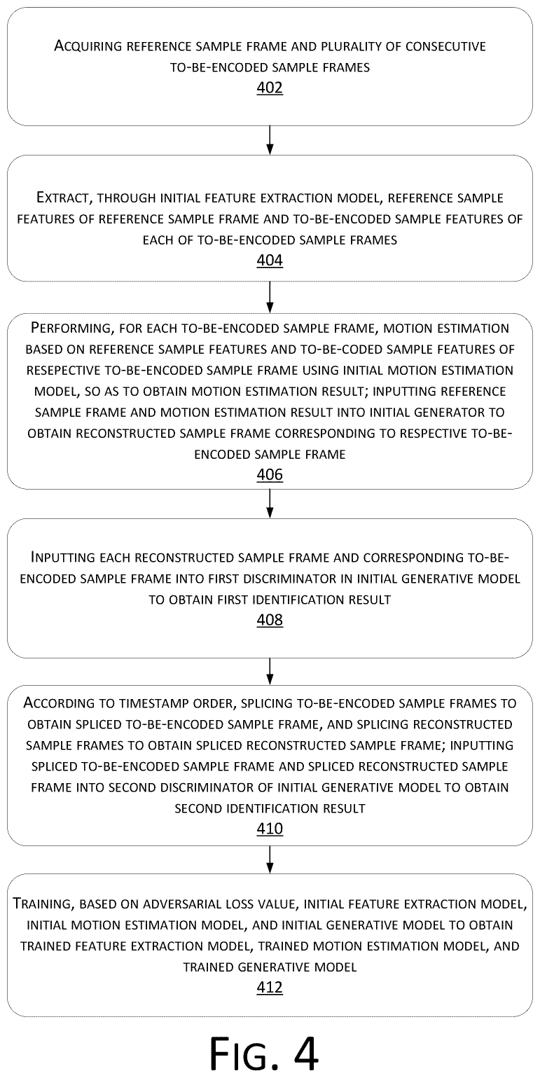

Please refer to FIG. 4, which is a flowchart of steps of a model training method according to Embodiment II of the present disclosure. For example, the model training method provided in this embodiment comprises the following steps:

S402: acquiring a reference sample frame and a plurality of consecutive to-be-encoded sample frames.

S404: extracting, through an initial feature extraction model, reference sample features of the reference sample frame and to-be-encoded sample features of each of the to-be-encoded sample frames.

S406: performing, for each to-be-encoded sample frame, motion estimation based on the reference sample features and the to-be-coded sample features of a respective to-be-encoded sample frame using an initial motion estimation model, so as to obtain the motion estimation result; inputting the reference sample frame and the motion estimation result into the initial generator to obtain the reconstructed sample frame corresponding to the respective to-be-encoded sample frames.

S408: inputting each reconstructed sample frame and the corresponding to-be-encoded sample frame into a first discriminator in the initial generative model to obtain a first identification result.

S410: according to a timestamp order, splicing the to-be-encoded sample frames to obtain a spliced to-be-encoded sample frame, and splicing the reconstructed sample frames to obtain a spliced reconstructed sample frame; inputting the spliced to-be-encoded sample frame and the spliced reconstructed sample frame into a second discriminator of the initial generative model to obtain a second identification result.

S412: training, based on the adversarial loss value, the initial feature extraction model, the initial motion estimation model, and the initial generative model to obtain a trained feature extraction model, a trained motion estimation model, and a trained generative model.

In the embodiment of the present disclosure, the specific implementation method of each step can be found in the corresponding steps of Embodiment II, which will not be repeated herein again.

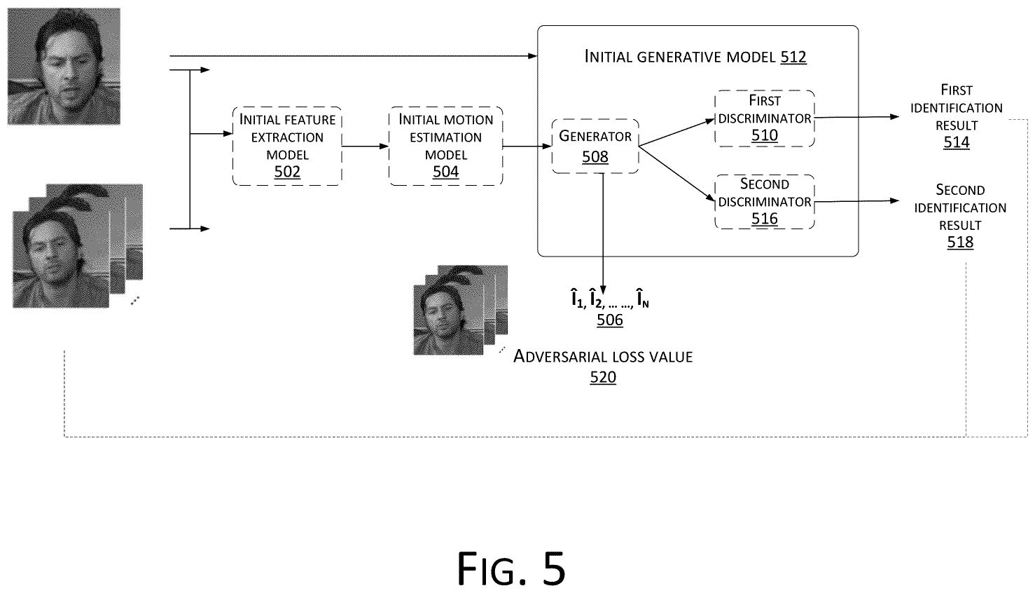

Please refer to FIG. 5, which is a schematic diagram of a scenario corresponding to the Embodiment I of the present disclosure. Hereinafter, the embodiment of the present disclosure will be described with reference to the schematic diagram shown in FIG. 5, using a specific scenario as an example:

A reference sample frame K and a plurality of consecutive to-be-encoded sample frames I₁, I₂, . . . , Iₙ are acquired; through an initial feature extraction model 502, reference sample features of the reference sample frame and to-be-encoded sample features of each of the to-be-encoded sample frames are extracted; for each to-be-encoded sample frame, motion estimation is performed based on the reference sample features and the to-be-coded sample features of the to-be-encoded sample frame using an initial motion estimation model 504, so as to obtain the motion estimation results; the reference sample frame K and the motion estimation results are inputted into the initial generator to obtain the reconstructed sample frames corresponding to the to-be-encoded sample frames. As such, the reconstructed sample frames: Î₁, Î₂, . . . , Îₙ 506 are outputted through the generator 508. Each reconstructed sample frame and the corresponding to-be-encoded sample frame are inputted into a first discriminator 510 in the initial generative model 512 to obtain a first identification result 514; according to a timestamp order, all the to-be-encoded sample frames are spliced to obtain a spliced to-be-encoded sample frame, and all the reconstructed sample frames are spliced to obtain a spliced reconstructed sample frame; the spliced to-be-encoded sample frame and the spliced reconstructed sample frame are inputted into a second discriminator 516 of the initial generative model 512 to obtain a second identification result 518; based on the adversarial loss value 520, the initial feature extraction model, the initial motion estimation model, and the initial generative model 512 are trained to obtain a trained feature extraction model, a trained motion estimation model, and a trained generative model.

The model training method provided in the embodiments of the present disclosure generates reconstructed sample frames corresponding to a plurality of consecutive to-be-coded sample frames through the generator in the initial generative model. While an authenticity identification on a single reconstructed sample frame and the corresponding to-be-encoded sample frame is performed, another authenticity identification is also performed on the spliced reconstructed sample frame spliced together from all the reconstructed sample frames in the timestamp order and the spliced to-be-encoded sample frame spliced together from all the to-be-encoded sample frames in the timestamp order. As such, the adversarial loss value is generated based on the identification results from the single sample frames (first identification results) and the identification results from the spliced sample frames (second identification results), thereby completing the training of the initial generative model. That is to say, in the embodiments of the present disclosure, when an authenticity identification is performed, not only the similarity between the reconstructed sample frame and the to-be-encoded sample frame in the spatial domain is considered, the similarity between the reconstructed sample frame and the to-be-encoded sample frame in the temporal domain is also considered. In other words, by comparing the similarity between the spliced to-be-encoded sample frame and the spliced reference sample frame, it is considered whether there is a continuous relationship between the consecutive reconstructed sample frames in the temporal domain that is present in the consecutive to-be-encoded sample frames. Therefore, by training the model based on the above identification results and reconstructing the video frames based on the trained generative model, the reconstructed video frame sequences can be kept consistent with the to-be-encoded video frame sequences in the temporal domain, thereby improving the phenomena of flickering and floating artifacts and enhancing the video reconstruction quality.

The model training method of the embodiment may be executed by any appropriate electronic device with data capabilities, including but not limited to: servers, PCs, and the like.

### Embodiment III

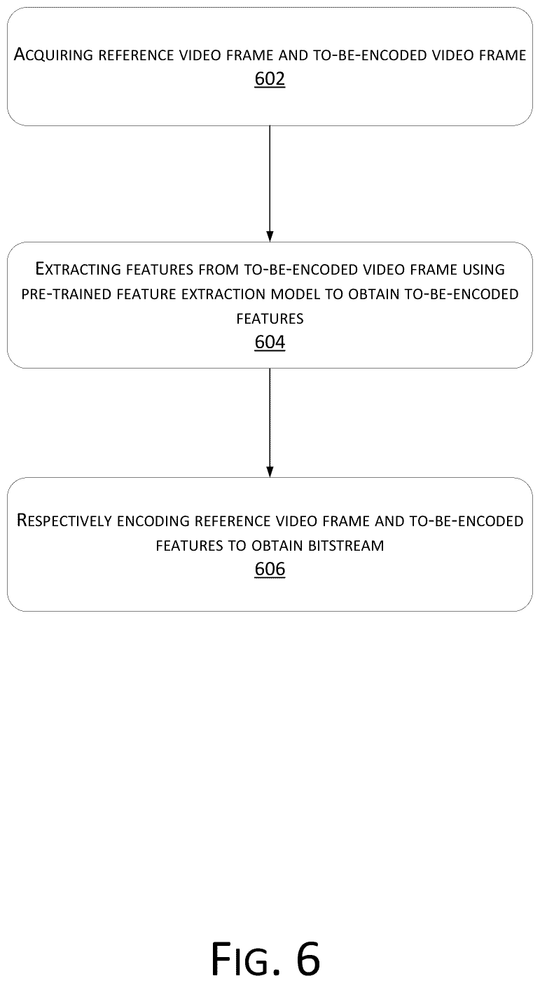

Please refer to FIG. 6, which is a flowchart of steps of a video encoding method according to Embodiment III of the present disclosure. For example, the video encoding provided in this embodiment comprises the following steps:

S602: acquiring a reference video frame and a to-be-encoded video frame.

S604: extracting features from the to-be-encoded video frame using a pre-trained feature extraction model to obtain to-be-encoded features.

The feature extraction model is obtained through the model training method of Embodiment II.

S606: respectively encoding the reference video frame and the to-be-encoded features to obtain a bitstream.

The video encoding method of the embodiment may be executed by any appropriate electronic device with data capabilities, including but not limited to: servers, PCs, and the like.

The video encoding method provided in Embodiment III of the present disclosure may be executed by a video encoding end (encoder) to encode video files with different resolutions, especially facial video files, so as to compress the digital bandwidth of the video files. The method may be applied to various scenarios, examples of which include: storage and streaming transmission of conventional video games involving faces with various resolutions. For example, the video frames of the video game may be encoded by the video encoding method provided by the embodiment of the present disclosure to form a corresponding video bitstream for storage and transmission in a video streaming service or other similar applications. Other examples are low-latency scenarios such as video conferencing and live video broadcasting. For example, the facial video data with various resolutions collected by a video acquisition device may be encoded by the video encoding method provided in the embodiment of the present disclosure to form a corresponding video bitstream, which is sent to a conference terminal; and the video bitstream is decoded by the conference terminal so as to obtain corresponding facial video pictures. A further example is a virtual reality scenario, where the facial video data with various resolutions collected by a video acquisition device may be encoded by the facial video encoding method provided in the embodiment of the present disclosure to form a corresponding video bitstream, which is sent to a virtual reality related device (such as VR virtual glasses and the like); the video bitstream is decoded through the VR device to obtain corresponding facial video pictures, the corresponding VR function is implemented based on the facial video pictures, and so on.

### Embodiment IV

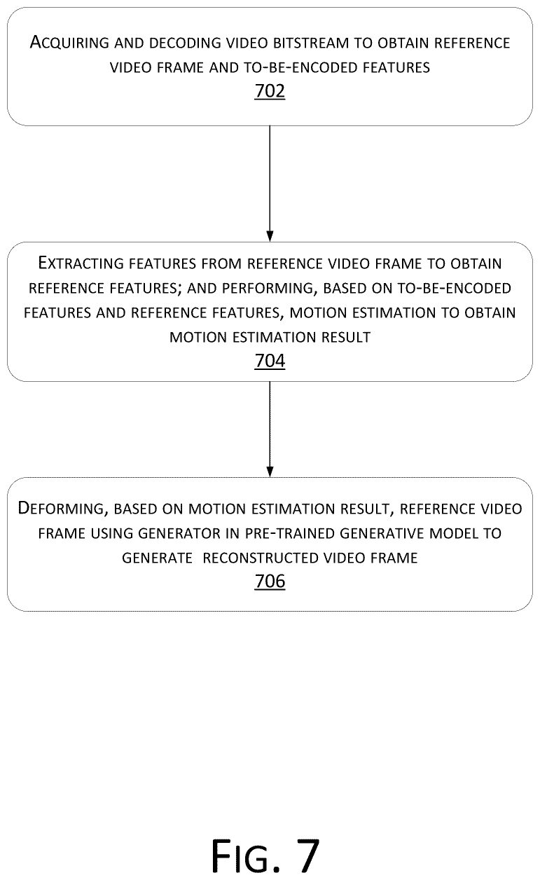

Please refer to FIG. 7, which is a flowchart of steps of a video decoding method according to Embodiment IV of the present disclosure. For example, the video decoding method provided in this embodiment comprises the following steps:

S702: acquiring and decoding a video bitstream to obtain a reference video frame and to-be-encoded features.

S704: extracting features from the reference video frame to obtain reference features; and performing, based on the to-be-encoded features and the reference features, motion estimation to obtain a motion estimation result.

S706: deforming, based on the motion estimation result, the reference video frame using a generator in a pre-trained generative model to generate a reconstructed video frame.

Herein, the generative model is obtained using the model training method according to the first aspect or the second aspect.

In the video decoding method provided in the embodiment of the present disclosure, the generative model is trained and obtained in the following manner: reconstructed sample frames corresponding to a plurality of consecutive to-be-coded sample frames are generated through the generator in the initial generative model; while an authenticity identification on a single reconstructed sample frame and the corresponding to-be-encoded sample frame is performed, another authenticity identification is also performed on the spliced reconstructed sample frame spliced together from all the reconstructed sample frames in the timestamp order and the spliced to-be-encoded sample frame spliced together from all the to-be-encoded sample frames in the timestamp order. As such, the adversarial loss value is generated based on the identification results from the single sample frames (first identification results) and the identification results from the spliced sample frames (second identification results), and the training of the initial generative model may then be completed. That is to say, when an authenticity identification is performed, not only the similarity between the reconstructed sample frame and the to-be-encoded sample frame in the spatial domain is considered, the similarity between the reconstructed sample frame and the to-be-encoded sample frame in the temporal domain is also considered. In other words, by comparing the similarity between the spliced to-be-encoded sample frame and the spliced reference sample frame, it is considered whether there is a continuous relationship between the consecutive reconstructed sample frames in the temporal domain that is present in the consecutive to-be-encoded sample frames. Therefore, by training the model based on the above identification results and decoding the video frames based on the trained generative model, the reconstructed video frame sequences can be kept consistent with the to-be-encoded video frame sequences in the temporal domain, thereby improving the phenomena of flickering and floating artifacts and enhancing the video reconstruction quality.

The video decoding method of the embodiment may be executed by any appropriate electronic device with data capabilities, including but not limited to: servers, PCs, and the like.

### Embodiment V

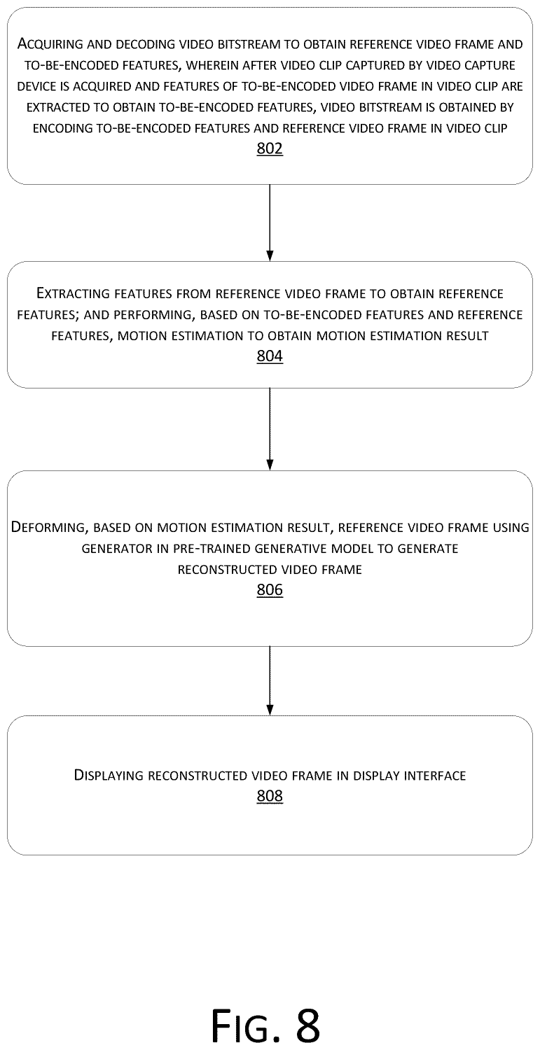

Please refer to FIG. 8, which is a flowchart of steps of a video decoding method according to Embodiment V of the present disclosure. An application scenario of the video decoding method is as follows: a video acquisition device acquires a conference video clip; after the encoder extracts the features of the to-be-encoded video frames in the clip to obtain the to-be-encoded features, the to-be-encoded features and the reference video frames in the video clip are encoded to obtain a video bitstream, which is sent to a conference terminal; the conference terminal decodes the video bitstream to obtain the corresponding conference video pictures and displays the same.

For example, the video decoding method provided in this embodiment comprises the following steps:

S802: acquiring and decoding a video bitstream to obtain a reference video frame and to-be-encoded features, wherein after a video clip captured by a video capture device is acquired and features of a to-be-encoded video frame in the video clip are extracted to obtain to-be-encoded features, the video bitstream is obtained by encoding the to-be-encoded features and the reference video frame in the video clip.

S804: extracting features from the reference video frame to obtain reference features; and performing, based on the to-be-encoded features and the reference features, motion estimation to obtain a motion estimation result.

S806: deforming, based on the motion estimation result, the reference video frame using a generator in a pre-trained generative model to generate a reconstructed video frame.

Herein, the generative model is obtained using the model training method according to the first aspect or the second aspect.

S808: displaying the reconstructed video frame in a display interface.

In the video decoding method provided in the embodiment of the present disclosure, the generative model is trained and obtained in the following manner: reconstructed sample frames corresponding to a plurality of consecutive to-be-coded sample frames are generated through the generator in the initial generative model; while an authenticity identification on a single reconstructed sample frame and the corresponding to-be-encoded sample frame is performed, another authenticity identification is also performed on the spliced reconstructed sample frame spliced together from all the reconstructed sample frames in the timestamp order and the spliced to-be-encoded sample frame spliced together from all the to-be-encoded sample frames in the timestamp order. As such, the adversarial loss value is generated based on the identification results from the single sample frames (first identification results) and the identification results from the spliced sample frames (second identification results), and the training of the initial generative model may then be completed. That is to say, in the embodiments of the present disclosure, when an authenticity identification is performed, not only the similarity between the reconstructed sample frame and the to-be-encoded sample frame in the spatial domain is considered, the similarity between the reconstructed sample frame and the to-be-encoded sample frame in the temporal domain is also considered. In other words, by comparing the similarity between the spliced to-be-encoded sample frame and the spliced reference sample frame, it is considered whether there is a continuous relationship between the consecutive reconstructed sample frames in the temporal domain that is present in the consecutive to-be-encoded sample frames. Therefore, by training the model based on the above identification results and reconstructing the video frames based on the trained generative model, the reconstructed video frame sequences can be kept consistent with the to-be-encoded video frame sequences in the temporal domain, thereby improving the phenomena of flickering and floating artifacts and enhancing the video reconstruction quality.

The video decoding method of the embodiment may be executed by any appropriate electronic device with data capabilities, including but not limited to: servers, PCs, and the like.

### Embodiment VI

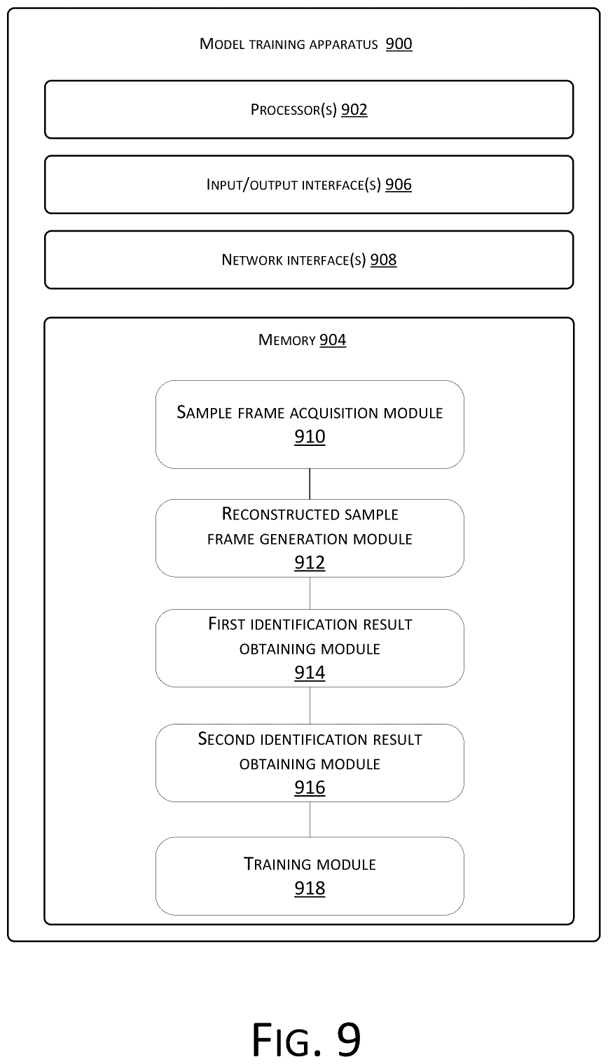

Please refer to FIG. 9, which is a structural block diagram of a model training apparatus 900 according to Embodiment VI of the present disclosure. For example, as shown in FIG. 9, the model training apparatus 900 includes one or more processor(s) 902 or data processing unit(s) and memory 904. The model training apparatus 900 may further include one or more input/output interface(s) 906 and one or more network interface(s) 908.

The memory 904 is an example of computer readable media. The computer readable media include non-volatile and volatile media as well as movable and non-movable media, and can implement information storage by using any method or technology. Information may be a computer readable instruction, a data structure, and a module of a program or other data. An example of the storage media of a computer includes, but is not limited to, a phase-change memory (PRAM), a static random access memory (SRAM), a dynamic random access memory (DRAM), other types of RAMs, a ROM, an electrically erasable programmable read-only memory (EEPROM), a flash memory or other memory technologies, a compact disc read-only memory (CD-ROM), a digital versatile disc (DVD) or other optical storages, a cassette tape, a magnetic tape/magnetic disk storage or other magnetic storage devices, or any other non-transmission media, and can be used to store information accessible by the computing device. According to the definition in this text, the computer readable media does not include transitory computer readable media or transitory media such as a modulated data signal and carrier.

The memory 904 may store therein a plurality of modules or units including:
a sample frame acquisition module 910, configured for acquiring a reference sample frame and a plurality of consecutive to-be-encoded sample frames;
a reconstructed sample frame generation module 912, configured for deforming the reference sample frame by using a generator in an initial generative model to generate reconstructed sample frames corresponding to each of the to-be-encoded sample frames;
a first identification result obtaining module 914, configured for inputting each reconstructed sample frame and the corresponding to-be-encoded sample frame into a first discriminator in the initial generative model to obtain a first identification result;
a second identification result obtaining module 916, configured for, according to a timestamp order, splicing all the to-be-encoded sample frames to obtain a spliced to-be-encoded sample frame, and splicing all the reconstructed sample frames to obtain a spliced reconstructed sample frame; inputting the spliced to-be-encoded sample frame and the spliced reconstructed sample frame into a second discriminator of the initial generative model to obtain a second identification result; and
a training module 918, configured for obtaining an adversarial loss value based on the first identification result and the second identification result, and training the initial generative model based on the adversarial loss value to obtain a trained generative model.

For example, in some embodiments, the adversarial loss value include: a generative adversarial loss value, a spatial adversarial loss value, and a temporal adversarial loss value;
the training module 918, when executing the step of obtaining the adversarial loss value based on the first identification result and the second identification result, is, for example, configured for:
obtaining the generative adversarial loss value based on the first identification result of each reconstructed sample frame;
obtaining the spatial adversarial loss value based on a difference between the first identification result of each reconstructed sample frame and the first identification result of the corresponding to-be-encoded sample frame; and
obtaining the temporal adversarial loss value based on a difference between the second identification result of the spliced to-be-encoded sample frame and the second identification result of the spliced reconstructed sample frame.

For example, in some embodiments, when the training module 918 executes the step of obtaining the generative adversarial loss value based on the first identification result of each reconstructed sample frame, it is, for example, configured for:
acquiring a probability distribution of the first identification result of each reconstructed sample frame as a first reconstruction probability distribution for each reconstructed sample frame; and obtaining the generative adversarial loss value based on an expected value of the first reconstruction probability distribution for each reconstructed sample frame.

When the training module 918 executes the step of obtaining the spatial adversarial loss value based on a difference between the first identification result of each reconstructed sample frame and the first identification result of the corresponding to-be-encoded sample frame, it is, for example, configured for:
acquiring a probability distribution of the first identification result of each to-be-encoded sample frame as a first to-be-encoded probability distribution for each to-be-encoded sample frame; and obtaining the spatial adversarial loss value based on an expected difference between the expected value of the first reconstructed probability distribution for each reconstructed sample frame and an expected value of the first to-be-encoded probability distribution for each to-be-encoded sample frame.

When the training module 918 executes the step of obtaining the temporal adversarial loss value based on a difference between the second identification result of the spliced to-be-encoded sample frame and the second identification result of the spliced reconstructed sample frame, it is, for example, configured for:
acquiring a probability distribution of the second identification result of the spliced reconstructed sample frame as a second reconstructed probability distribution; acquiring a probability distribution of the second identification result of the spliced to-be-encoded sample frame as a second to-be-encoded probability distribution; and obtaining the temporal adversarial loss value based on an expected difference between an expected value of the second reconstructed probability distribution and an expected value of the second to-be-encoded probability distribution.

For example, in some embodiments, the model training apparatus further comprises:
a perceptual loss value obtaining module, configured for, prior to training the initial generative model based on the adversarial loss value to obtain a trained generative model, generating a perceptual loss value based on each reconstructed sample frame and each to-be-encoded sample frame;
the training module 918, when executing the step of training the initial generative model based on the adversarial loss value to obtain a trained generative model, is, for example, configured for:
training the initial generative model based on the adversarial loss value and the perceptual loss value to obtain the trained generative model.

For example, in some embodiments, the reconstructed sample frame generation module 904 is configured for:
performing, based on the reference sample frame, motion estimation on each to-be-encoded sample frame to obtain a motion estimation result for each to-be-encoded sample frame;
inputting, for each to-be-encoded sample frame, the reference sample frame and the motion estimation results of the to-be-encoded sample frame into the generator of the initial generative model, and deforming the reference sample frame through the generator to generate the reconstructed sample frames corresponding to the to-be-encoded sample frames.

The model training apparatus further comprises:
an optical flow loss value generation module, configured for, prior to training the initial generative model based on the adversarial loss value and the perceptual loss value to obtain the trained generative model, inputting each to-be-encoded sample frame into a pre-trained motion prediction module to obtain actual motion results corresponding to each of the to-be-encoded samples; and generating an optical flow loss value based on a difference between the motion estimation results and the actual motion results of each of the to-be-encoded sample frames;
the training module 918, when executing the step of training the initial generative model based on the adversarial loss value and the perceptual loss value to obtain the trained generative model, is, for example, configured for:
training the initial generative model based on the adversarial loss value, the perceptual loss value, and the optical flow loss value to obtain the trained generative model.

For example, in some embodiments, when the optical flow loss value generating module performs the step of generating an optical flow loss value based on a difference between the motion estimation results and the actual motion results of each of the to-be-encoded sample frames, it is configured for:
calculating, for each to-be-encoded sample frame, the difference between the motion estimation result and the actual motion result thereof as a motion difference corresponding to the to-be-encoded sample frame; and
summing each motion difference as the total motion difference;
The ratio of the total motion difference to the total number of to-be-encoded sample frames is calculated as the optical flow loss value.

For example, in some embodiments, the reconstructed sample frame generation module 904 is configured for:
extracting, through an initial feature extraction model, reference sample features of the reference sample frame and to-be-encoded sample features of each of the to-be-encoded sample frames; and
performing, for each to-be-encoded sample frame, motion estimation based on the reference sample features and the to-be-coded sample features of the to-be-encoded sample frame using an initial motion estimation model, so as to obtain the motion estimation results; inputting the reference sample frame and the motion estimation results into the initial generator to obtain the reconstructed sample frames corresponding to the to-be-encoded sample frames.

The training module 918, when executing the step of training the initial generative model based on the adversarial loss value to obtain a trained generative model, is, for example, configured for:
training, based on the adversarial loss value, the initial feature extraction model, the initial motion estimation model, and the initial generative model to obtain a trained feature extraction model, a trained motion estimation model, and a trained generative model.

The model training apparatus in this embodiment is used for implementing the corresponding model training methods in the multiple method embodiments described above and has the beneficial effects of the corresponding method embodiments, which will not be elaborated herein again. In addition, for the functional implementation of each module in the model training apparatus of this embodiment, the description of the corresponding parts in the aforementioned method embodiments can be referred to, which will not be repeated herein.

### Embodiment VII

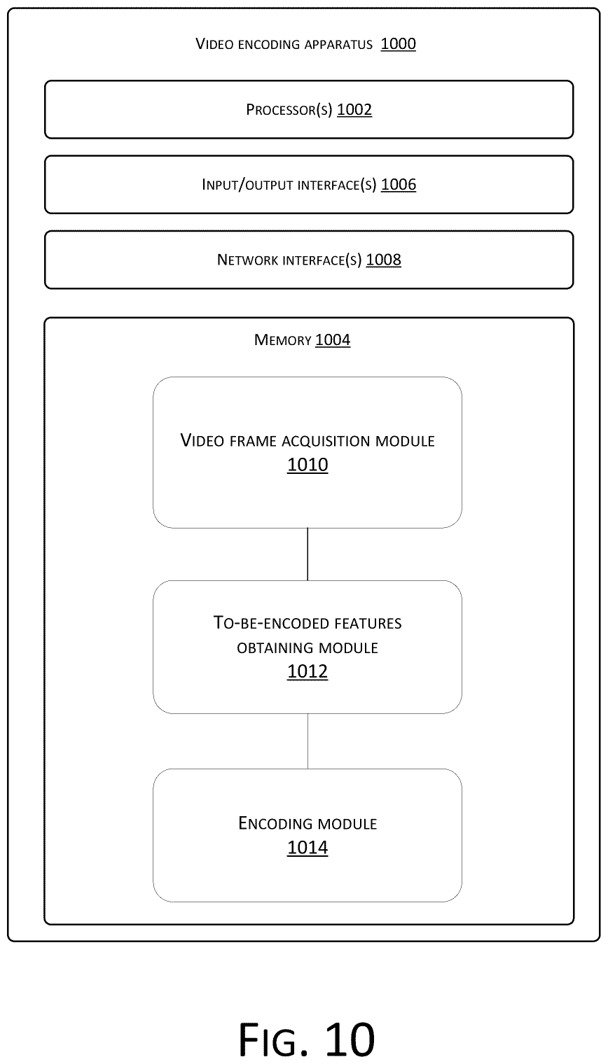

Please refer to FIG. 10, which is a structural block diagram of a video encoding apparatus 1000 according to Embodiment VII of the present disclosure. For example, as shown in FIG. 10, the video encoding apparatus 1000 includes one or more processor(s) 1002 or data processing unit(s) and memory 1004. The video encoding apparatus 1000 may further include one or more input/output interface(s) 1006 and one or more network interface(s) 1008.

The memory 1004 is an example of computer readable media. The memory 1004 may store therein a plurality of modules or units including:
a video frame acquisition module 1010, configured for acquiring a reference video frame and a to-be-encoded video frame;
a to-be-encoded features obtaining module 1012, configured for extracting features from the to-be-encoded video frame using a pre-trained feature extraction model to obtain to-be-encoded features; and
an encoding module 1014, configured for respectively encoding the reference video frame and the to-be-encoded features to obtain a bitstream;

The feature extraction model is obtained through the model training method of Embodiment II.

The video encoding apparatus in this embodiment is used for implementing the corresponding video encoding methods in the multiple method embodiments described above and has the beneficial effects of the corresponding method embodiments, which will not be elaborated herein again. In addition, the functional implementation of each module in the video encoding apparatus of this embodiment can be referred to the description of the corresponding parts in the aforementioned method embodiments, and will not be repeated herein.

### Embodiment VIII

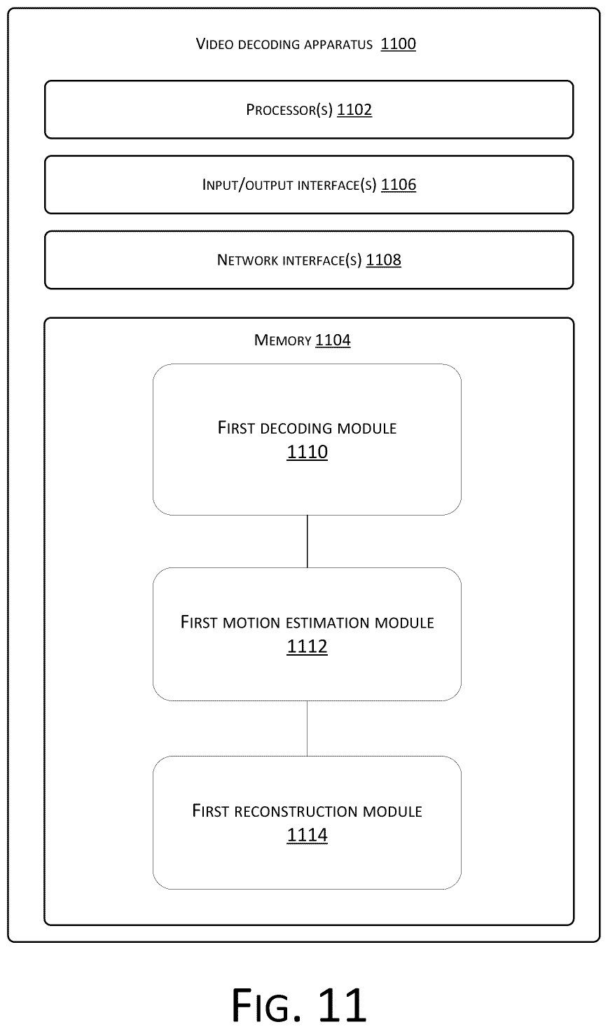

Please refer to FIG. 11, which is a structural block diagram of a video decoding apparatus 1100 according to Embodiment VIII of the present disclosure. For example, as shown in FIG. 11, the video decoding apparatus 1100 includes one or more processor(s) 1102 or data processing unit(s) and memory 1104. The video decoding apparatus 1100 may further include one or more input/output interface(s) 1106 and one or more network interface(s) 1108.

The memory 1104 is an example of computer readable media. The memory 1104 may store therein a plurality of modules or units including:
a first decoding module 1110, configured for acquiring and decoding a video bitstream to obtain a reference video frame and to-be-encoded features;
a first motion estimation module 1112, configured for extracting features from the reference video frame to obtain reference features; and performing, based on the to-be-encoded features and the reference features, motion estimation to obtain a motion estimation result; and
a first reconstruction module 1114, configured for deforming, based on the motion estimation result, the reference video frame using a generator in a pre-trained generative model to generate a reconstructed video frame.

Herein, the generative model is obtained through the model training method of the above-mentioned Embodiment I or Embodiment II.

The video decoding apparatus in this embodiment is used for implementing the corresponding video decoding methods in the multiple method embodiments described above and has the beneficial effects of the corresponding method embodiments, which will not be elaborated herein again. In addition, the functional implementation of each module in the video decoding apparatus of this embodiment can be referred to the description of the corresponding parts in the aforementioned method embodiments, and will not be repeated herein.

### Embodiment IX

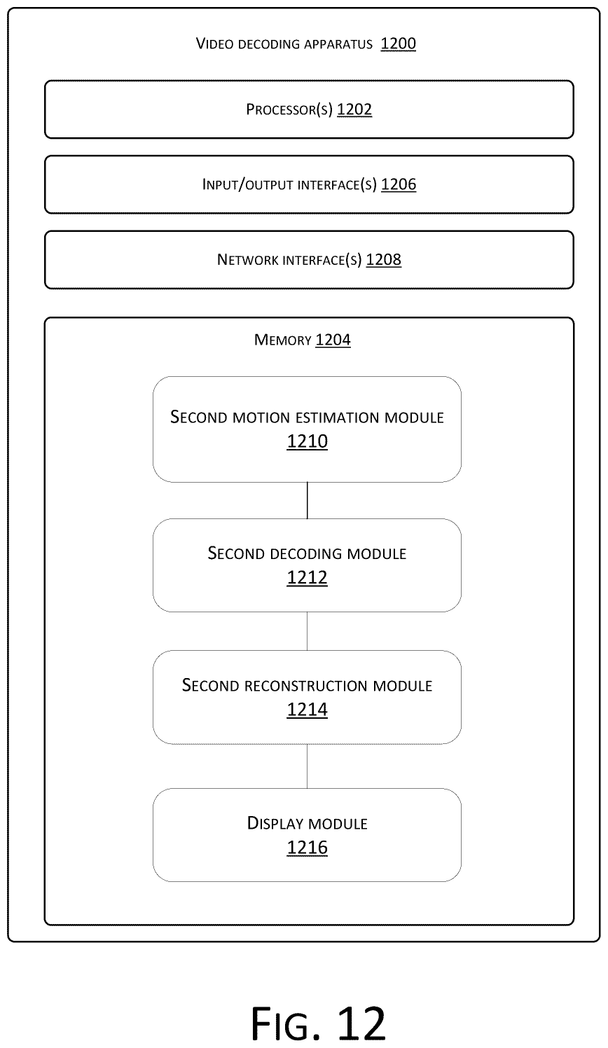

Please refer to FIG. 12, which is a structural block diagram of a video decoding apparatus 1200 according to Embodiment IX of the present disclosure. For example, as shown in FIG. 12, the video decoding apparatus 1200 includes one or more processor(s) 1202 or data processing unit(s) and memory 1204. The video decoding apparatus 1200 may further include one or more input/output interface(s) 1206 and one or more network interface(s) 1208.

The memory 1204 is an example of computer readable media. The memory 1204 may store therein a plurality of modules or units including:
a second decoding module 1210, configured for acquiring and decoding a video bitstream to obtain a reference video frame and to-be-encoded features, wherein after a video clip captured by a video capture device is acquired and features of a to-be-encoded video frame in the video clip are extracted to obtain to-be-encoded features, the video bitstream is obtained by encoding the to-be-encoded features and the reference video frame in the video clip;
a second motion estimation module 1212, configured for extracting features from the reference video frame to obtain reference features; and performing, based on the to-be-encoded features and the reference features, motion estimation to obtain a motion estimation result;
a second reconstruction module 1214, configured for deforming, based on the motion estimation result, the reference video frame using a generator in a pre-trained generative model to generate a reconstructed video frame; and
a display module 1216, configured for displaying the reconstructed video frame in a display interface;
Herein, the generative model is obtained through the model training method of the above-mentioned Embodiment I or Embodiment II.

The video decoding apparatus in this embodiment is used for implementing the corresponding video decoding methods in the multiple method embodiments described above and has the beneficial effects of the corresponding method embodiments, which will not be elaborated herein again. In addition, the functional implementation of each module in the video decoding apparatus of this embodiment can be referred to the description of the corresponding parts in the aforementioned method embodiments, and will not be repeated herein.

### Embodiment X

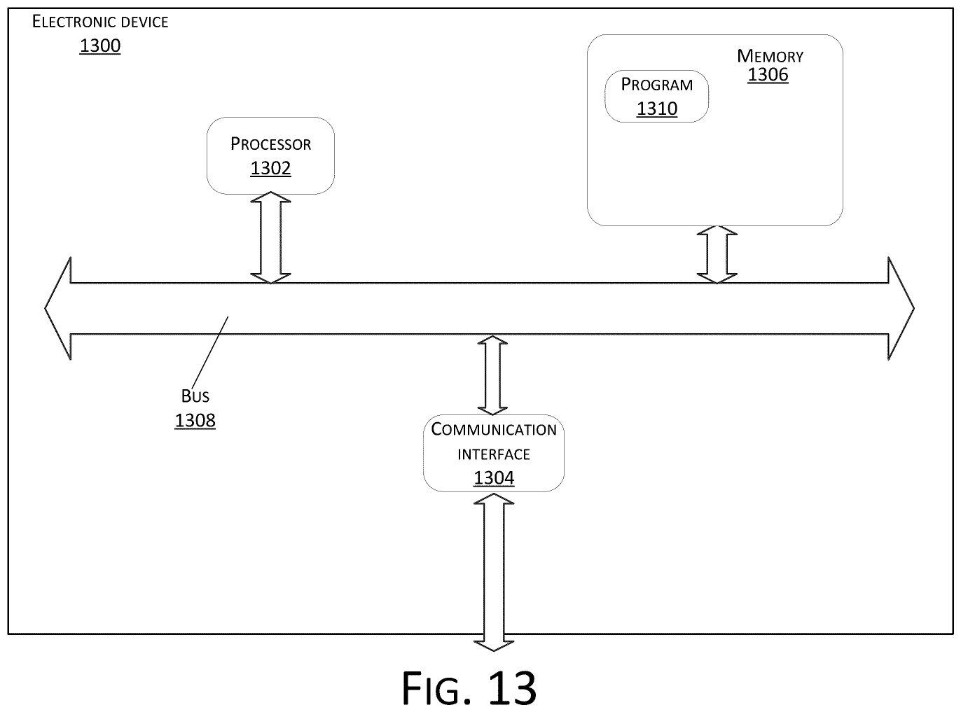

Please refer to FIG. 13, which shows a schematic structural diagram of an electronic device provided in Embodiment X of the present invention. The implementation manners of the electronic device are not limited thereby.

As shown in FIG. 13, an electronic device 1300 may comprise: a processor 1302, a communications interface 1304, a memory 1306, and a communications bus 1308.

Here,
the processor 1302, the communications interface 1304, and the memory 1306 communicate with each other through the communications bus 1308.

The communications interface 1304 is configured to communicate with other electronic devices or servers.

The processor 1302 is configured to execute a program 1310, and may execute the relevant steps in the above-mentioned model training, video encoding, or video decoding method embodiments.

For example, the program 1310 may include program codes, and the program codes include computer operation instructions.

The processor 1302 may be a central processing unit (CPU), or an application specific integrated circuit (ASIC), or one or more integrated circuits configured to implement the embodiments of the present disclosure. One or more processors included in a smart device may be the same type of processors, such as one or more CPUs; or may be different types of processors, such as one or more CPUs and one or more ASICs.

The memory 1306 is configured to store the program 1310. The memory 1306 may include a high-speed random-access memory (RAM), and may also include a non-volatile memory such as at least one disk memory.

The program 1310 may be configured to enable the processor 1302 to perform the following operations: acquiring a reference sample frame and a plurality of consecutive to-be-encoded sample frames; deforming the reference sample frame through a generator in an initial generative model to generate reconstructed sample frames corresponding to each of the to-be-encoded sample frames; inputting each reconstructed sample frame and the corresponding to-be-encoded sample frame into a first discriminator in the initial generative model to obtain a first identification result; splicing the to-be-encoded sample frames in a timestamp order to obtain a spliced to-be-encoded sample frame, and splicing the reconstructed sample frames to obtain a spliced reconstructed sample frame; inputting the spliced to-be-encoded sample frame and the spliced reconstructed sample frame into a second discriminator in the initial generative model to obtain a second identification result; obtaining an adversarial loss value based on the first identification result and the second identification result; and training the initial generative model based on the adversarial loss value to obtain a trained generative model.

Alternatively, the program 1310 may be configured to enable the processor 1302 to perform the following operations: acquiring a reference video frame and a to-be-encoded video frame; extracting features from the to-be-encoded video frame using a pre-trained feature extraction model to obtain to-be-encoded features; respectively encoding the reference video frame and the to-be-encoded features to obtain a bitstream, wherein the generative model is obtained through the model training method according to the above-mentioned second aspect.

Alternatively, the program 1310 may be configured for enabling the processor 1302 to perform the following operations: acquiring and decoding a video bitstream to obtain a reference video frame and to-be-encoded features; extracting features from the reference video frame to obtain reference features; and performing, based on the to-be-encoded features and the reference features, motion estimation to obtain a motion estimation result; deforming, based on the motion estimation result, the reference video frame using a generator in a pre-trained generative model to generate a reconstructed video frame, wherein the generated model is obtained through the model training method according to the above-mentioned first aspect or second aspect.

Alternatively, the program 1310 may be configured for enabling the processor 1302 to perform the following operations: acquiring and decoding a video bitstream to obtain a reference video frame and to-be-encoded features; after a video clip captured by a video capture device is acquired and features of a to-be-encoded video frame in the video clip are extracted to obtain to-be-encoded features, the video bitstream is obtained by encoding the to-be-encoded features and the reference video frame in the video clip; extracting features from the reference video frame to obtain reference features; and performing, based on the to-be-encoded features and the reference features, motion estimation to obtain a motion estimation result; deforming, based on the motion estimation result, the reference video frame using a generator in a pre-trained generative model to generate a reconstructed video frame; displaying the reconstructed video frame in a display interface, wherein the generated model is obtained through the model training method according to the above-mentioned first aspect or second aspect.

For the implementation of each step in the program 1310, reference may be made to the corresponding description of the corresponding steps and units in the above-described model training, video encoding, or video decoding method embodiments, which will not be elaborated herein. Those skilled in the art can clearly understand that, for the convenience and brevity of description, reference may be made to the corresponding process descriptions in the above-described method embodiments for the specific working process of the above-described devices and modules, which will not be elaborated here.

The electronic device provided in the embodiments of the present disclosure generates reconstructed sample frames corresponding to a plurality of consecutive to-be-coded sample frames through the generator in the initial generative model. While an authenticity identification on a single reconstructed sample frame and the corresponding to-be-encoded sample frame is performed, another authenticity identification is also performed on the spliced reconstructed sample frame spliced together from all the reconstructed sample frames in the timestamp order and the spliced to-be-encoded sample frame spliced together from all the to-be-encoded sample frames in the timestamp order. As such, the adversarial loss value is generated based on the identification results from the single sample frames (first identification results) and the identification results from the spliced sample frames (second identification results), and the training of the initial generative model may then be completed. That is to say, in the embodiments of the present disclosure, when an authenticity identification is performed, not only the similarity between the reconstructed sample frame and the to-be-encoded sample frame in the spatial domain is considered, the similarity between the reconstructed sample frame and the to-be-encoded sample frame in the temporal domain is also considered. In other words, by comparing the similarity between the spliced to-be-encoded sample frame and the spliced reference sample frame, it is considered whether there is a continuous relationship between the consecutive reconstructed sample frames in the temporal domain that is present in the consecutive to-be-encoded sample frames. Therefore, by training the model based on the above identification results and reconstructing the video frames based on the trained generative model, the reconstructed video frame sequences can be kept consistent with the to-be-encoded video frame sequences in the temporal domain, thereby improving the phenomena of flickering and floating artifacts and enhancing the video reconstruction quality.

Further provided in an embodiment of the present disclosure is a computer program product that comprises computer instructions, which instruct a computing device to execute operations corresponding to any one of the above-mentioned multiple method embodiments.

It should be noted that according to the needs of implementation, each component/step described in the embodiments of the present disclosure may be split into more components/steps, or two or more components/steps or some operations of components/steps may be combined into new components/steps to achieve the purpose of the embodiments of the present disclosure.

The above-described methods according to the embodiments of the present disclosure may be implemented in hardware, firmware, or implemented as software or computer codes that may be stored in a recording medium (such as CD ROMs, RAMs, floppy disks, hard disks, or magneto-optical disks), or implemented as computer codes downloaded over a network and originally stored in a remote recording medium or non-transitory machine-readable medium and to be stored in a local recording medium, so that the methods described herein can be processed by such software stored on a recording medium using a general-purpose computer, a special-purpose processor or programmable or dedicated hardware (such as ASICs or FPGAs). It can be appreciated that a computer, a processor, a microprocessor controller, or programmable hardware includes storage components (for example, RAMs, ROMs, flash memories, etc.) that can store or receive software or computer codes, and the software or computer codes, when accessed and executed by the computer, processor, or hardware, implement the model training methods, video encoding methods, or the video decoding methods described herein. Further, when a general-purpose computer accesses codes for implementing the model training methods, the video encoding methods, or the video decoding methods described herein, the execution of the codes converts the general-purpose computer to a dedicated computer for performing the model training methods, the video encoding methods, or the video decoding methods described herein.

Those of ordinary skill in the art can realize that the units and method steps of each example described in conjunction with the embodiments disclosed herein can be implemented in electronic hardware or a combination of computer software and electronic hardware. Whether these functions are performed in hardware or software depends on the application and design constraints of the technical solution. Those skilled in the art may implement the described functions using different methods for each application, but such implementation should not be considered to be beyond the scope of the embodiments of the present disclosure.

The above-described implementation manners are only used to illustrate the embodiments of the present disclosure, but not to limit the embodiments of the present disclosure. Those of ordinary skill in the art can also make various changes and modifications without departing from the spirit and scope of the embodiments of the present disclosure. Therefore, all equivalent technical solutions also belong to the scope of the embodiments of the present invention, and the scope of patent protection of the embodiments of the present disclosure should be defined by the claims.

The present disclosure may further be understood with clauses as follows:

Clause 1. A model training method comprising:
acquiring a reference sample frame and a plurality of consecutive to-be-encoded sample frames;
deforming the reference sample frame by using a generator in an initial generative model to generate a reconstructed sample frame corresponding to each of the to-be-encoded sample frames;
inputting each reconstructed sample frame and a corresponding to-be-encoded sample frame into a first discriminator in the initial generative model to obtain a first identification result;
according to a timestamp order, splicing the to-be-encoded sample frames to obtain a spliced to-be-encoded sample frame, and splicing reconstructed sample frames to obtain a spliced reconstructed sample frame;
inputting the spliced to-be-encoded sample frame and the spliced reconstructed sample frame into a second discriminator of the initial generative model to obtain a second identification result; and
obtaining an adversarial loss value based on the first identification result and the second identification result, and training the initial generative model based on the adversarial loss value to obtain a trained generative model.

Clause 2. The method according to clause 1, wherein:
the adversarial loss value comprises: a generative adversarial loss value, a spatial adversarial loss value, and a temporal adversarial loss value; and
the obtaining the adversarial loss value based on the first identification result and the second identification result comprises:
   obtaining the generative adversarial loss value based on the first identification result of each reconstructed sample frame;
   obtaining the spatial adversarial loss value based on a difference between the first identification result of each reconstructed sample frame and the first identification result of the corresponding to-be-encoded sample frame; and
   obtaining the temporal adversarial loss value based on a difference between the second identification result of the spliced to-be-encoded sample frame and the second identification result of the spliced reconstructed sample frame.

Clause 3. The method according to clause 2, wherein:
the obtaining the generative adversarial loss value based on the first identification result of each reconstructed sample frame comprises:
   acquiring a probability distribution of the first identification result of each reconstructed sample frame as a first reconstruction probability distribution for each reconstructed sample frame; and
   obtaining the generative adversarial loss value based on an expected value of a first reconstruction probability distribution for each reconstructed sample frame;
the obtaining the spatial adversarial loss value based on the difference between the first identification result of each reconstructed sample frame and the first identification result of the corresponding to-be-encoded sample frame comprises:
   acquiring a probability distribution of the first identification result of each to-be-encoded sample frame as a first to-be-encoded probability distribution for each to-be-encoded sample frame; and
   obtaining the spatial adversarial loss value based on an expected difference between the expected value of a first reconstructed probability distribution for each reconstructed sample frame and an expected value of the first to-be-encoded probability distribution for each to-be-encoded sample frame; and
the obtaining the temporal adversarial loss value based on the difference between the second identification result of the spliced to-be-encoded sample frame and the second identification result of the spliced reconstructed sample frame comprises:
   acquiring a probability distribution of the second identification result of the spliced reconstructed sample frame as a second reconstructed probability distribution;
   acquiring a probability distribution of the second identification result of the spliced to-be-encoded sample frame as a second to-be-encoded probability distribution; and
   obtaining the temporal adversarial loss value based on an expected difference between an expected value of the second reconstructed probability distribution and an expected value of the second to-be-encoded probability distribution.

Clause 4. The method according to clause 1, wherein:
prior to training the initial generative model based on the adversarial loss value to obtain the trained generative model, the method further comprises generating a perceptual loss value based on each reconstructed sample frame and each to-be-encoded sample frame; and
the training the initial generative model based on the adversarial loss value to obtain the trained generative model comprises training the initial generative model based on the adversarial loss value and the perceptual loss value to obtain the trained generative model.

Clause 5. The method according to clause 4, wherein:
the deforming the reference sample frame by using the generator in the initial generative model to generate reconstructed sample frames corresponding to each of the to-be-encoded sample frames comprises:
   performing, based on the reference sample frame, motion estimation on each to-be-encoded sample frame to obtain a motion estimation result for each to-be-encoded sample frame; and
   inputting, for each to-be-encoded sample frame, the reference sample frame and motion estimation results of the to-be-encoded sample frames into the generator of the initial generative model, and deforming the reference sample frame through the generator to generate the reconstructed sample frames corresponding to the to-be-encoded sample frames;
prior to training the initial generative model based on the adversarial loss value and the perceptual loss value to obtain the trained generative model, the method further comprises:
   inputting each to-be-encoded sample frame into a pre-trained motion prediction module to obtain actual motion results corresponding to each of the to-be-encoded sample frames; and
   generating an optical flow loss value based on a difference between the motion estimation results and the actual motion results of each of the to-be-encoded sample frames; and
the training the initial generative model based on the adversarial loss value and the perceptual loss value to obtain the trained generative model comprises training the initial generative model based on the adversarial loss value, the perceptual loss value, and the optical flow loss value to obtain the trained generative model.

Clause 6. The method according to clause 5, wherein the generating the optical flow loss value based on the difference between the motion estimation results and actual motion results of each of the to-be-encoded sample frames comprises:
calculating, for a respective to-be-encoded sample frame, the difference between the motion estimation result and the actual motion result thereof as a motion difference corresponding to the respective to-be-encoded sample frame; and
summing each motion difference as the optical flow loss value.

Clause 7. The method according to clause 1, wherein:
the deforming the reference sample frame by using the generator in the initial generative model to generate reconstructed sample frames corresponding to each of the to-be-encoded sample frame comprises:
   extracting, through an initial feature extraction model, reference sample features of the reference sample frame and to-be-encoded sample features of each of the to-be-encoded sample frames;
   performing, for a respective to-be-encoded sample frame, motion estimation based on the reference sample features and the to-be-encoded sample features of the respective to-be-encoded sample frame using an initial motion estimation model to obtain a motion estimation result; and
   inputting the reference sample frame and the motion estimation result into the initial generator to obtain the reconstructed sample frames corresponding to the respective to-be-encoded sample frame; and
the training the initial generative model based on the adversarial loss value to obtain the trained generative model comprises training, based on the adversarial loss value, the initial feature extraction model, the initial motion estimation model, and the initial generative model to obtain a trained feature extraction model, a trained motion estimation model, and a trained generative model.

Clause 8. A video encoding method comprising:
acquiring a reference video frame and a to-be-encoded video frame;
extracting features from the to-be-encoded video frame using a pre-trained feature extraction model to obtain to-be-encoded features; and
respectively encoding the reference video frame and the to-be-encoded features to obtain a bitstream,
wherein a feature extraction model is obtained using the model training method described in clause 7.

Clause 9. A video decoding method comprising:
acquiring and decoding a video bitstream to obtain a reference video frame and to-be-encoded features;
extracting features from the reference video frame to obtain reference features;
performing motion estimation based on the to-be-encoded features and the reference features to obtain a motion estimation result; and
deforming, based on the motion estimation result, the reference video frame using a generator in a pre-trained generative model to generate a reconstructed video frame,
wherein a generative model is obtained using the model training method described in any one of clauses 1-7.

Clause 10. A video decoding method, applied to a conference terminal device, comprising:
acquiring and decoding a video bitstream to obtain a reference video frame and to-be-encoded features, wherein after a video clip captured by a video capture device is acquired and features of a to-be-encoded video frame in the video clip are extracted to obtain to-be-encoded features, the video bitstream is obtained by encoding the to-be-encoded features and the reference video frame in the video clip;
extracting features from the reference video frame to obtain reference features; and performing, based on the to-be-encoded features and the reference features, motion estimation to obtain a motion estimation result;
deforming, based on the motion estimation result, the reference video frame using a generator in a pre-trained generative model to generate a reconstructed video frame; and
displaying the reconstructed video frame in a display interface,
wherein a generative model is obtained using the model training method described in any one of clauses 1-7.

Clause 11. An electronic device comprising:
a processor;
a memory;
a communications interface; and
a communications bus,
wherein:
the processor, the memory, and the communications interface communicate with each other through the communications bus; and
the memory is configured to store at least one executable instruction that enables the processor to execute operations corresponding to the model training method as described in any one of clauses 1-7, operations corresponding to the video encoding method as described in clause 8, or operations corresponding to the video decoding method as described in clause 9 or 10.

Clause 12. A computer storage medium having stored thereon a computer program, which, when executed by a processor, implements the model training method as described in any one of clauses 1 to 7, the video encoding method as described in clause 8, or the video decoding method as described in clause 9 or 10.

Clause 13. A computer program product comprising computer instructions, wherein the computer instructions instruct a computing device to perform operations corresponding to the model training method as described in any one of clauses 1 to 7, operations corresponding to the video encoding method as described in clause 8, or operations corresponding to the video decoding method as described in clause 9 or 10.

What is claimed is:

1. A method comprising:
acquiring a reference sample frame and a plurality of consecutive to-be-encoded sample frames;
deforming the reference sample frame by using a generator in an initial generative model to generate a reconstructed sample frame corresponding to each of the to-be-encoded sample frames;
inputting each reconstructed sample frame and a corresponding to-be-encoded sample frame into a first discriminator in the initial generative model to obtain a first identification result;
according to a timestamp order, splicing the to-be-encoded sample frames to obtain a spliced to-be-encoded sample frame, and splicing reconstructed sample frames to obtain a spliced reconstructed sample frame;
inputting the spliced to-be-encoded sample frame and the spliced reconstructed sample frame into a second discriminator of the initial generative model to obtain a second identification result;
obtaining an adversarial loss value based on the first identification result and the second identification result; and
training the initial generative model based on the adversarial loss value to obtain a trained generative model.

2. The method according to claim 1, wherein the adversarial loss value comprises:
a generative adversarial loss value;
a spatial adversarial loss value; and
a temporal adversarial loss value.

3. The method according to claim 2, wherein the obtaining the adversarial loss value based on the first identification result and the second identification result comprises:
obtaining the generative adversarial loss value based on the first identification result of each reconstructed sample frame;
obtaining the spatial adversarial loss value based on a difference between the first identification result of each reconstructed sample frame and the first identification result of the corresponding to-be-encoded sample frame; and
obtaining the temporal adversarial loss value based on a difference between the second identification result of the spliced to-be-encoded sample frame and the second identification result of the spliced reconstructed sample frame.

4. The method according to claim 3, wherein the obtaining the generative adversarial loss value based on the first identification result of each reconstructed sample frame comprises:
acquiring a probability distribution of the first identification result of each reconstructed sample frame as a first reconstruction probability distribution for each reconstructed sample frame; and
obtaining the generative adversarial loss value based on an expected value of a first reconstruction probability distribution for each reconstructed sample frame.

5. The method according to claim 3, wherein the obtaining the spatial adversarial loss value based on the difference between the first identification result of each reconstructed sample frame and the first identification result of the corresponding to-be-encoded sample frame comprises:
acquiring a probability distribution of the first identification result of each to-be-encoded sample frame as a first to-be-encoded probability distribution for each to-be-encoded sample frame; and
obtaining the spatial adversarial loss value based on an expected difference between the expected value of a first reconstructed probability distribution for each reconstructed sample frame and an expected value of the first to-be-encoded probability distribution for each to-be-encoded sample frame.

6. The method according to claim 3, wherein the obtaining the temporal adversarial loss value based on the difference between the second identification result of the spliced to-be-encoded sample frame and the second identification result of the spliced reconstructed sample frame comprises:
acquiring a probability distribution of the second identification result of the spliced reconstructed sample frame as a second reconstructed probability distribution;
acquiring a probability distribution of the second identification result of the spliced to-be-encoded sample frame as a second to-be-encoded probability distribution; and
obtaining the temporal adversarial loss value based on an expected difference between an expected value of the second reconstructed probability distribution and an expected value of the second to-be-encoded probability distribution.

7. The method according to claim 1, wherein prior to training the initial generative model based on the adversarial loss value to obtain the trained generative model, the method further comprises generating a perceptual loss value based on each reconstructed sample frame and each to-be-encoded sample frame.

8. The method according to claim 7, wherein the training the initial generative model based on the adversarial loss value to obtain the trained generative model comprises training the initial generative model based on the adversarial loss value and the perceptual loss value to obtain the trained generative model.

9. The method according to claim 7, wherein the deforming the reference sample frame by using the generator in the initial generative model to generate reconstructed sample frames corresponding to each of the to-be-encoded sample frames comprises:
performing, based on the reference sample frame, motion estimation on each to-be-encoded sample frame to obtain a motion estimation result for each to-be-encoded sample frame; and
inputting, for each to-be-encoded sample frame, the reference sample frame and motion estimation results of the to-be-encoded sample frames into the generator of the initial generative model, and deforming the reference sample frame through the generator to generate the reconstructed sample frames corresponding to the to-be-encoded sample frames.

10. The method according to claim 9, prior to training the initial generative model based on the adversarial loss value and the perceptual loss value to obtain the trained generative model, the method further comprises:
inputting each to-be-encoded sample frame into a pre-trained motion prediction module to obtain actual motion results corresponding to each of the to-be-encoded sample frames; and
generating an optical flow loss value based on a difference between the motion estimation results and the actual motion results of each of the to-be-encoded sample frames.

11. The method according to claim 10, wherein the training the initial generative model based on the adversarial loss value and the perceptual loss value to obtain the trained generative model comprises training the initial generative model based on the adversarial loss value, the perceptual loss value, and the optical flow loss value to obtain the trained generative model.

12. The method according to claim 10, wherein the generating the optical flow loss value based on the difference between the motion estimation results and actual motion results of each of the to-be-encoded sample frames comprises:
calculating, for a respective to-be-encoded sample frame, the difference between the motion estimation result and the actual motion result thereof as a motion difference corresponding to the respective to-be-encoded sample frame; and
summing each motion difference as the optical flow loss value.

13. The method according to claim 1, wherein the deforming the reference sample frame by using the generator in the initial generative model to generate reconstructed sample frames corresponding to each of the to-be-encoded sample frame comprises:
extracting, through an initial feature extraction model, reference sample features of the reference sample frame and to-be-encoded sample features of each of the to-be-encoded sample frames;
performing, for a respective to-be-encoded sample frame, motion estimation based on the reference sample features and the to-be-encoded sample features of the respective to-be-encoded sample frame using an initial motion estimation model to obtain a motion estimation result; and
inputting the reference sample frame and the motion estimation result into the initial generator to obtain the reconstructed sample frames corresponding to the respective to-be-encoded sample frame.

14. The method according to claim 13, wherein the training the initial generative model based on the adversarial loss value to obtain the trained generative model comprises training, based on the adversarial loss value, the initial feature extraction model, the initial motion estimation model, and the initial generative model to obtain a trained feature extraction model, a trained motion estimation model, and a trained generative model.

15. A video decoding method comprising:
acquiring and decoding a video bitstream to obtain a reference video frame and to-be-encoded features;
extracting features from the reference video frame to obtain reference features;
performing motion estimation based on the to-be-encoded features and the reference features to obtain a motion estimation result; and
deforming, based on the motion estimation result, the reference video frame using a generator in a pre-trained generative model to generate a reconstructed video frame.

16. The video decoding method according to claim 15, further comprising obtaining the pre-trained generative model, the obtaining the pre-trained generative model including:
acquiring a reference sample frame and a plurality of consecutive to-be-encoded sample frames;
deforming the reference sample frame by using a generator in an initial generative model to generate a reconstructed sample frame corresponding to each of the to-be-encoded sample frames;
inputting each reconstructed sample frame and a corresponding to-be-encoded sample frame into a first discriminator in the initial generative model to obtain a first identification result;
according to a timestamp order, splicing the to-be-encoded sample frames to obtain a spliced to-be-encoded sample frame, and splicing reconstructed sample frames to obtain a spliced reconstructed sample frame;
inputting the spliced to-be-encoded sample frame and the spliced reconstructed sample frame into a second discriminator of the initial generative model to obtain a second identification result;
obtaining an adversarial loss value based on the first identification result and the second identification result; and
training the initial generative model based on the adversarial loss value to obtain a trained generative model.

17. The video decoding method according to claim 16, wherein:
the deforming the reference sample frame by using the generator in the initial generative model to generate reconstructed sample frames corresponding to each of the to-be-encoded sample frame comprises:
extracting, through an initial feature extraction model, reference sample features of the reference sample frame and to-be-encoded sample features of each of the to-be-encoded sample frames;
performing, for a respective to-be-encoded sample frame, motion estimation based on the reference sample features and the to-be-encoded sample features of the respective to-be-encoded sample frame using an initial motion estimation model to obtain a motion estimation result; and
inputting the reference sample frame and the motion estimation result into the initial generator to obtain the reconstructed sample frames corresponding to the respective to-be-encoded sample frame; and
the training the initial generative model based on the adversarial loss value to obtain the trained generative model comprises training, based on the adversarial loss value, the initial feature extraction model, the initial motion estimation model, and the initial generative model to obtain a trained feature extraction model, a trained motion estimation model, and a trained generative model.

18. An apparatus comprising:
one or more processors; and
one or more memories storing thereon computer-readable instructions that, when executed by the one or more processors, cause the one or more processors to perform acts comprising:
acquiring and decoding a video bitstream to obtain a reference video frame and to-be-encoded features;
extracting features from the reference video frame to obtain reference features; and performing, based on the to-be-encoded features and the reference features, motion estimation to obtain a motion estimation result;
deforming, based on the motion estimation result, the reference video frame using a generator in a pre-trained generative model to generate a reconstructed video frame; and
displaying the reconstructed video frame in a display interface.

19. The apparatus according to claim 18, wherein after a video clip captured by a video capture device is acquired and features of a to-be-encoded video frame in the video clip are extracted to obtain to-be-encoded features, obtaining the video bitstream by encoding the to-be-encoded features and the reference video frame in the video clip.

20. The apparatus according to claim 18, wherein the acts further comprise obtaining the pre-trained generative model, the obtaining the pre-trained generative model including:
acquiring a reference sample frame and a plurality of consecutive to-be-encoded sample frames;
deforming the reference sample frame by using a generator in an initial generative model to generate a reconstructed sample frame corresponding to each of the to-be-encoded sample frames;
inputting each reconstructed sample frame and a corresponding to-be-encoded sample frame into a first discriminator in the initial generative model to obtain a first identification result;
according to a timestamp order, splicing the to-be-encoded sample frames to obtain a spliced to-be-encoded sample frame, and splicing reconstructed sample frames to obtain a spliced reconstructed sample frame;
inputting the spliced to-be-encoded sample frame and the spliced reconstructed sample frame into a second discriminator of the initial generative model to obtain a second identification result;
obtaining an adversarial loss value based on the first identification result and the second identification result; and
training the initial generative model based on the adversarial loss value to obtain a trained generative model.
